(19) United States
(12) Patent Application Publication
(10) Pub. No.: US 2014/0206437 A1
(43) Pub. Date: Jul. 24, 2014

(54) GAME OBJECT GAMBLING HYBRID GAMES

(71) Applicant: Gamblit Gaming, LLC, Glendale, CA (US)

(72) Inventors: Miles Arnone, Sherborn, MA (US); Frank Cire, Pasadena, CA (US); Eric Meyerhofer, Pasadena, CA (US); Caitlyn Ross, Sherborn, MA (US)

(73) Assignee: Gamblit Gaming, LLC, Glendale, CA (US)

(21) Appl. No.: 14/222,520

(22) Filed: Mar. 21, 2014

Related U.S. Application Data
(63) Continuation of application No. PCT/US13/38301, filed on Apr. 25, 2013.
(60) Provisional application No. 61/637,921, filed on Apr. 25, 2012.

(51) Int. Cl. G07F 17/32; A63F 9/24

(52) U.S. Cl. CPC G07F 17/3244
USPC 463/25

(57) ABSTRACT

Systems and methods in accordance with embodiments of the invention operate a game object gambling hybrid game including a gambling game providing a game of chance and an entertainment game providing a game of skill, where the game object gambling hybrid game is constructed to: manage the entertainment game and communicate detection of at least one player action as a game object gambling event occurrence to the gambling game, where the game object gambling event occurrence causes a game object wager payout as a randomly generated payout of gameplay resources executed by the gambling game; and generate a game object action based upon the game object wager payout and communicate the game object action to the entertainment game, where the entertainment game is configured to modify entertainment game gameplay based upon the game object action.

### CROSS REFERENCE TO RELATED APPLICATIONS

This application is a continuation of Patent Cooperation Treaty Application No. PCT/US13/38295, filed Apr. 25, 2013, which claims the benefit of U.S. Provisional Patent Application No. 61/637,924, filed on Apr. 25, 2012, the contents of each of which are hereby incorporated by reference in their entirety as if stated in full herein. This patent application references Patent Cooperation Treaty Application No. PCT/US11/26768, filed Mar. 1, 2011, Patent Cooperation Treaty Application No. PCT/US11/63587, filed Dec. 6, 2011, and Patent Cooperation Treaty Application No. PCT/US12/58156, filed Sep. 29, 2012, the contents of each of which are hereby incorporated by reference in their entirety as if stated in full herein.

### FIELD OF THE INVENTION

Embodiments of the present invention are generally related to gaming and more specifically to game object gambling hybrid games that include both an entertainment game and a gambling game where user interactions with a game object integrated within an entertainment game can trigger gambling games based upon the game object.

### BACKGROUND

The gaming machine manufacturing industry has traditionally developed gaming machines with a gambling game. A gambling game is typically a game of chance, which is a game where the outcome of the game is generally dependent solely on chance (such as a slot machine). A game of chance can be contrasted with a game of skill where the outcome of the game can depend upon a player's skill with the game. Gambling games are typically not as interactive and do not include graphics as sophisticated as an entertainment game, which is a game of skill such as a video game.

### SUMMARY OF THE INVENTION

Systems and methods in accordance with embodiments of the invention operate a game object gambling hybrid game. One embodiment includes a game object gambling hybrid game, including a real world engine constructed to: receive from a game object, a trigger of a wager of real world credits; determine a gambling outcome of the wager of real world credits; and transmit the gambling outcome to the game object. The game object gambling hybrid game further includes an entertainment software engine coupled to the real world engine, the entertainment software engine constructed to: execute an entertainment game providing entertainment game outcomes based upon skillful execution of the entertainment game; and modify entertainment game gameplay of the entertainment game based upon a game object action related to the game object, wherein the game object is constructed to: communicate the trigger to the real world engine, the trigger determined by detection of a player action in the entertainment game that satisfies a gambling event occurrence rule, whereby the player action triggers the wager of real world credits in the real world engine; receive the gambling outcome from the real world engine; generate the game object action based upon the gambling outcome in accordance with a game object wager payout rule; and communicate the game object action to the entertainment software engine.

In some embodiments, the real world engine and the game object communicate via a network.

In various embodiments, the gambling outcome is a predetermined gambling outcome.

In some embodiments, the game object gambling event occurrence rule detects the player action a consumption of one or more elements in the entertainment game, wherein the one or more elements are a limited resource consumed within the entertainment game to advance entertainment game gameplay.

In many embodiments, the game object action includes restoration of the one or more elements to the entertainment game.

In some embodiments, the game object gambling event occurrence rule detects the player action as an achievement of a combination of elements associated with a player profile, where the elements are a limited resource consumed within the entertainment game to advance entertainment game gameplay.

In various embodiments, the game object is further constructed to utilize a wager term configuration rule that configures wager terms based upon the game object gambling event occurrence.

In numerous embodiments, the game object is a game object server coupled to the entertainment software engine.

In some embodiments, the entertainment software engine is further constructed to: request the game object from a game object server; and install the game object in the entertainment game.

In some embodiments, a method of a game object gambling hybrid game is provided. The method includes executing by first one or more processors a real world engine process including: receiving from a game object, a trigger of a wager of real world credits; determining a gambling outcome of the wager of real world credits; and transmitting the gambling outcome to the game object. The method further includes executing by second one or more processors an entertainment software engine process including: executing an entertainment game providing entertainment game outcomes based upon skillful execution of the entertainment game; and modifying entertainment game gameplay of the entertainment game based upon a game object action related to the game object. The method further includes executing by the second one or more processors a game object process including: communicating the trigger to the real world engine process, the trigger determined by detection of a player action in the entertainment game that satisfies a gambling event occurrence rule, whereby the player action triggers the wager of real world credits in the real world engine process; receiving the gambling outcome from the real world engine; generating the game object action based upon the gambling outcome in accordance with a game object wager payout rule; and communicating the game object action to the entertainment software engine process.

Another embodiment includes a game object gambling hybrid game, including: an entertainment software engine constructed to: execute an entertainment game providing outcomes based upon skillful execution of an entertainment game; and modify entertainment game gameplay of the entertainment game based upon a game object action related to at least one game object; and a game object including: a real world engine constructed to provide a randomly generated game object wager payout of gameplay resources in response to a game object wager in accordance with a game object wager execution rule; and a game world engine constructed to: communicate detection of at least one player action satisfying at least one game object gambling event occurrence rule as a game object gambling event occurrence to the real world engine, where the game object gambling event occurrence triggers the game object wager in the real world engine; and generate the game object action based upon the game object wager payout in accordance with a game object wager payout rule; and communicate the game object action to the entertainment software engine.

In a further embodiment, the real world engine includes a real world engine client and a real world engine server in communication with the real world engine client over a network; and the game object wager execution rule configures the real world engine to produce the game object wager payout in response to the game object gambling event occurrence by using the real world engine client to communicate with the real world engine server to return the game object wager payout to the real world engine client.

In another embodiment, the real world engine includes a real world engine client and an outcome server in communication with the real world engine client over a network; and the game object wager execution rule configures the real world engine to produce the game object wager payout in response to the game object gambling event occurrence by using the real world engine client to receive at least one predetermined gambling outcome requested from an outcome server and to produce the game object wager payout based upon the predetermined gambling outcome and the game object gambling event occurrence.

In a still further embodiment, the predetermined gambling outcome is a randomly generated value from a random number generator implemented using the outcome server that can be utilized by the real world engine in conjunction with a pay table to produce the game object wager payout.

In still another embodiment, the real world engine includes a real world engine client, an outcome server and a redemption server; and the game object wager execution rule configures the real world engine to produce the game object wager payout in response to a game object gambling event occurrence by using the real world engine client to: receive at least one certificate from the outcome server, where the at least one certificate includes a predetermined gambling outcome; receive a positive certificate authentication result requested from a redemption server that confirms that the at least one certificate is authentic; and produce the game object wager payout based upon the positive certificate authentication result, predetermined gambling outcome and the game object gambling event occurrence.

In a yet further embodiment, the predetermined gambling outcome is a randomly generated value from a random number generator implemented using the outcome server that can be utilized by the real world engine in conjunction with a pay table to produce the game object wager payout.

In yet another embodiment, the gameplay resources wagered in a game object wager includes gameplay resources selected from the group consisting of: real world credits, game world credits and elements, where elements are a limited resource consumed within the entertainment game to advance entertainment game gameplay.

In a further embodiment again, the gameplay resources wagered in a game object wager includes real world credits.

In another embodiment again, the game object gambling event occurrence rule detects the game object gambling event occurrence as a player action that is a consumption of an element, where an element is a limited resource consumed within the entertainment game to advance entertainment game gameplay.

In a further additional embodiment, the game object gambling event occurrence rule detects the game object gambling event occurrence as a player action that achieves a combination of elements associated with a player profile, where elements are a limited resource consumed within the entertainment game to advance entertainment game gameplay.

In another additional embodiment, the game object wager execution rule configures the real world engine to produce a game object wager payout from a game object wager of gameplay resources associated with a player profile with wager terms configured in accordance with at least one game object wager execution rule, where the wager terms match a random value generated from a real world engine's random number generator with a pay table used to produce the game object wager payout.

In a still yet further embodiment, at least one wager term configuration rule configures wager terms based upon the game object gambling event occurrence.

In still yet another embodiment, the game object wager execution rule configures the real world engine to produce a game object wager payout from a game object wager of gameplay resources associated with a player profile using a random value generated from the real world engine's random number generator and a pay table.

In a still further embodiment again, a player is an electronic representation of interactions associated with a player profile of the game object gambling hybrid game.

In still another embodiment again, the game object is a gun in a shooter themed entertainment game that can respond to a player action of shooting the gun by having the target of the gun take on damage in the context of the entertainment game.

In a still further additional embodiment, the game object wager execution rule configures the real world engine to produce the game object wager payout in response to the game object gambling event occurrence by using a pay table associated with a game object.

In still another additional embodiment, the game object wager execution rule configures the real world engine to produce the game object wager payout in response to the game object gambling event occurrence by producing the game object wager payout using information generated prior to a time of the game object gambling event occurrence.

In a yet further embodiment again, the game object wager execution rule configures the real world engine to produce the game object wager payout in response to the game object gambling event occurrence by producing the game object wager payout using information generated after a time of the game object gambling event occurrence.

Yet another embodiment again includes a method of operating a game object gambling hybrid game, including: executing, by an entertainment software engine, an entertainment game providing outcomes based upon skillful execution of the entertainment game; communicating detection of at least one player action satisfying at least one game object gambling event occurrence rule as a game object gambling event occurrence, by a game world engine of a game object, to a real world engine of the game object, where the game object gambling event occurrence triggers a game object wager of real world credits in the real world engine; providing, by the real world engine of the game object, a randomly generated game object wager payout of real world credits in response to the game object wager in accordance with a game object wager execution rule; generating, by the game world engine of the game object, a game object action based upon the game object wager payout in accordance with a game object wager payout rule; communicating, by the game world engine of the game object to the entertainment software engine, the game object action; and modifying, by the entertainment software engine, entertainment game gameplay of the entertainment game based upon the game object action.

A yet further additional embodiment includes a machine readable medium containing processor instructions, where execution of the instructions by a processor causes the processor to perform a process including: executing, by an entertainment software engine, an entertainment game providing outcomes based upon skillful execution of the entertainment game; communicating detection of at least one player action satisfying at least one game object gambling event occurrence rule as a game object gambling event occurrence, by a game world engine of a game object, to a real world engine of the game object, where the game object gambling event occurrence triggers a game object wager of real world credits in the real world engine; providing, by the real world engine of the game object, a randomly generated game object wager payout of real world credits in response to the game object wager in accordance with a game object wager execution rule; generating, by the game world engine of the game object, a game object action based upon the game object wager payout in accordance with a game object wager payout rule; communicating, by the game world engine of the game object to the entertainment software engine, the game object action; and modifying, by the entertainment software engine, entertainment game gameplay of the entertainment game based upon the game object action.

### BRIEF DESCRIPTION OF THE DRAWINGS

FIG. 1 illustrates a game object gambling hybrid game in accordance with an embodiment of the invention.

FIG. 2 is a conceptual diagram that illustrates how resources are utilized in a game object gambling hybrid game in accordance with an embodiment of the invention.

FIG. 3 is a conceptual diagram that illustrates interplay between resources and components of a game object gambling hybrid game in accordance with an embodiment of the invention.

FIG. 4 is a timing diagram that illustrates a process of facilitating interactions between an entertainment game and a gambling game in accordance with embodiments of the invention.

FIG. 5 is a conceptual diagram that illustrates various components of a game object gambling hybrid game in accordance with an embodiment of the invention.

FIG. 6 is a system diagram that illustrates a network distributed game object gambling hybrid game in accordance with an embodiment of the invention.

FIG. 7 is a system diagram that illustrates an implementation of a network distributed game object gambling hybrid game with a local device user interface in accordance with an embodiment of the invention.

FIG. 8 is a system diagram that illustrates an implementation of a network distributed game object gambling hybrid game including a game world engine local server in accordance with an embodiment of the invention.

FIG. 9 is a system diagram that illustrates an implementation of a network distributed game object gambling hybrid game including a game world engine group server in accordance with an embodiment of the invention.

FIG. 10 is a system diagram that illustrates an implementation of an Internet distributed game object gambling hybrid game in accordance with an embodiment of the invention.

FIG. 11A is a conceptual diagram that illustrates an image of a bullet utilized in a game object gambling hybrid game representative of a game object in accordance with an embodiment of the invention.

FIG. 11B is a conceptual diagram that illustrates an image of a machine gun utilized in a game object gambling hybrid game representative of a game object in accordance with an embodiment of the invention.

FIG. 11C is a conceptual diagram that illustrates an image of a hand gun utilized in a game object gambling hybrid game representative of a game object in accordance with an embodiment of the invention.

FIG. 12 illustrates a flow chart of a process for adding a game object to a game object gambling hybrid game in accordance with an embodiment of the invention.

FIG. 13 illustrates a timing diagram of a process for adding a game object to a game object gambling hybrid game in accordance with an embodiment of the invention.

FIG. 14 illustrates a flow chart of a process for updating the game state of an entertainment game using a game object module in accordance with an embodiment of the invention.

FIG. 15 illustrates a timing diagram of a process for updating the game state of an entertainment game using a game object module using a real world engine in accordance with an embodiment of the invention.

FIG. 16 illustrates a timing diagram of a process for updating an entertainment game based upon a game object action using a real world engine distributed across a real world engine client and real world engine server in accordance with an embodiment of the invention.

FIG. 17 illustrates a flow chart of a process for determining a game object wager payout in accordance with an embodiment of the invention.

FIG. 18 illustrates a timing diagram of a process for determining a game object wager payout using an outcome server in accordance with an embodiment of the invention.

FIG. 19 illustrates a flow chart of a process for determining a game object wager payout using a certificate with predetermined gambling outcomes in accordance with an embodiment of the invention.

FIG. 20 illustrates a timing diagram of a process for determining a game object wager payout using a certificate with predetermined gambling outcomes in accordance with an embodiment of the invention.

FIG. 21 illustrates a hardware architecture diagram of a processing apparatus utilized in the implementation of a game object gambling hybrid game in accordance with an embodiment of the invention.

### DETAILED DESCRIPTION

Turning now to the drawings, systems and methods for operation of game object gambling hybrid games are illustrated. In several embodiments, a game object gambling hybrid game is a form of a hybrid game that includes an entertainment software engine (ESE) which executes an entertainment game that incorporates game objects for user entertainment, a real world engine (RWE) which manages a gambling game that includes game object wagers, as well as a game world engine (GWE) which manages the entertainment portion of the game object gambling hybrid game and manages the communication of game object gambling events in the entertainment game to the RWE. In several embodiments, the game world engine includes a game object module that handles the addition of game objects to the entertainment game executing on the ESE and the communication of payout tables associated with game object wagers to the RWE. In certain embodiments, the game object gambling hybrid game also includes a user interface associated with either or both the gambling game and the entertainment game. A player of a game object gambling hybrid game is the electronic representation of interactions, typically via a user interface, associated with a player profile of the game object gambling hybrid game. In operation of a game object gambling hybrid game, a player acts upon various types of elements of the entertainment game in a game world environment. Elements are a limited resource consumed within an entertainment game to advance entertainment game gameplay. In playing the entertainment game using the elements, a player can (optionally) consume and accrue game world credits (GWC) within the entertainment game. These credits can be in the form of (but are not limited to) game world credits, experience points, or points generally. Wagers can be made in the gambling game using real world credits (RWC). The real world credits can be credits in an actual currency, or can be credits in a virtual currency which has real world value. Gambling outcomes from the gambling game can cause consumption, loss or accrual of RWC. In addition, gambling outcomes in the gambling game can influence elements in the entertainment game such as (but not limited to) by restoring a consumed element, causing the loss of an element, restoration or placement of a fixed element. In certain embodiments, gambling games can facilitate the wager of GWC for a randomly generated payout of GWC or a wager of elements for a randomly generated payout of elements. In particular embodiments, an amount of GWC and/or elements used as part of a wager can have a RWC value if cashed out of a game object gambling hybrid game gameplay session. Example elements include enabling elements (EE) which are elements that enable a player's play of the entertainment game and whose consumption by the player while playing the entertainment game can trigger a wager in a gambling game. Another example of an element is a reserve enabling element (REE), which is an element that converts into one or more enabling elements upon occurrence of a release event in game object gambling hybrid game gameplay. Other types of elements include actionable elements (AE) which are elements that are acted upon to trigger a wager in the gambling game and cannot be restorable during normal play of the entertainment game. In progressing through entertainment game gameplay, elements can be utilized by a player during interactions with a controlled entity (CE) which is a character, entity, inanimate object, device or other object under control of a player. Also, entertainment game gameplay progress can be dependent upon: a required game object (RGO) which is a specific game object in an entertainment game acted upon for an AE to be completed (such as but not limited to a specific key needed to open a door); a required environmental condition (REC) which is a game state present within an entertainment game for an AE to be completed (such as but not limited to daylight whose presence enables a character to walk through woods); or a controlled entity characteristic (CEC) which is a status of the CE within an entertainment game for an AE to be completed (such as but not limited to a CE to have full health points before entering battle). Although various gameplay resources, such as but not limited to GWC, RWC and elements are discussed above, any gameplay resource can be utilized to advance game object gambling hybrid game gameplay as appropriate to the specification of a specific application in accordance with embodiments of the invention. Various hybrid games are discussed in Patent Cooperation Treaty Application No. PCT/US11/26768, filed Mar. 1, 2011, entitled ENRICHED GAME PLAY ENVIRONMENT (SINGLE and/or MULTIPLAYER) FOR CASINO APPLICATIONS and Patent Cooperation Treaty Application No. PCT/US11/63587, filed Dec. 6, 2011, entitled ENHANCED SLOT-MACHINE FOR CASINO APPLICATIONS each disclosure of which is hereby incorporated by reference in its entirety.

In numerous embodiments, a player action is an action during game object gambling hybrid game gameplay that can be performed by a player or to a player. In several embodiments, an entertainment game can include at least one game object. A game object is an object that a player can interact within during entertainment game gameplay progression, such as but not limited to bullets that a player can utilize to shoot a gun, a gun that can be utilized to damage an opponent or a soldier that a player can command to attack an enemy. The player's interaction with the game object during the entertainment game gameplay session can yield a game object action associated with the game object, such as but not limited to firing a bullet from a gun to damage an opponent, inflicting a specific type of damage on an enemy using a gun or a specific type of attack that damages an enemy as executed by a soldier. For example in certain embodiments where a game object is a gun in a shooter themed entertainment game, the gun can respond to a player action of shooting the gun by having the target of the gun take on a particular type of damage in the context of the entertainment game. A game object in game object gambling hybrid game gameplay can be associated with at least one game object wager specific to the game object which can generate a randomly generated game object wager payout based upon a player action that triggered the game object wager.

In many embodiments, a game object gambling hybrid game utilizes a game object module to modify the game state of the entertainment game and hence the entertainment game gameplay in response to a gambling outcome resulting from player action with a game object that triggers a gambling object wager. The modification to the entertainment game gameplay can be based upon a randomly generated game object wager payout from a game object wager in a gambling game triggered by the player action. In several embodiments, randomly generated game object wager payouts are pre-generated and utilized by the GWE to modify entertainment game gameplay in response to player actions with a game object in the entertainment game satisfying a game object gambling event occurrence rule. In many embodiments, the GWE engine initiates the random generation of a game object wager payout by the RWE in response to player actions with a game object in the entertainment game satisfying a game object gambling event occurrence rule. Based upon the game object wager payout by the RWE, the GWE can then modify entertainment game gameplay.

In several embodiments, a variety of gameplay resources can be wagered in a game object wager. The gameplay resources wagered in a game object wager can include any gameplay resources utilized in the performance of a game object gambling hybrid game including but not limited to real world credits, game world credits and elements. In certain embodiments, a game object wager payout can yield a payout of gameplay resources that are allocated to a player profile of a player that generated the player action.

In many embodiments, a game world engine can utilize a game object module to receive information concerning player actions relating to game objects within an entertainment game executing on an ESE. A game object gambling event occurrence can be based upon detection of at least one player action in accordance with a game object gambling event occurrence rule. The game object gambling event occurrence can be communicated to a real world engine that can be used to execute a gambling game with a game object wager. The game object gambling event occurrence can trigger a game object wager executed using the RWE in accordance with a game object wager execution rule to produce a game object wager payout as a randomly generated payout of gameplay resources. As noted above, the randomly generated payout can be pre-generated or generated in real time. A game object action can be generated based upon the game object wager payout in accordance with a game object wager payout rule, where the entertainment software engine is configured to modify entertainment game gameplay based upon the game object action.

In a number of embodiments, the real world engine can be executed as a distributed system with both a RWE client and a RWE server in communication with the RWE client over a network. A game object wager execution rule can configure the real world engine to produce a game object wager payout in response to the game object gambling event occurrence by using the RWE client to communicate with the RWE server to return the game object wager payout to the RWE client.

In numerous embodiments, a real world engine can be executed as a distributed system with a RWE client and an RWE outcome server in communication with the RWE client over a network. A game object wager execution rule can configure the real world engine to produce the game object wager payout in response to the game object gambling event occurrence by using the RWE client to receive at least one predetermined gambling outcome requested from an RWE outcome server and to produce the game object wager payout based upon the predetermined gambling outcome and the game object gambling event occurrence.

In many embodiments, a predetermined gambling outcome is information generated by a RWE that can be utilized to generate a game object wager payout set prior to triggering execution of the game object wager for the game object wager payout, such as but not limited to a random value generated by a RNG of a RWE. The random value can be configured to be utilized with a pay table to determine a game object wager payout. In a variety of embodiments, a predetermined gambling outcome can include both a random value generated by an RNG of a RWE along with an associated pay table that is to be utilized to interpret the random value to generate a game object wager payout.

In various embodiments, a real world engine can be executed as a distributed system with a RWE client, an RWE outcome server and a RWE redemption server. A game object wager execution rule can configure the RWE to produce a game object wager payout in response to the game object gambling event occurrence by using the RWE client to receive a certificate from the RWE outcome server. The certificate from an RWE outcome server can be configured to be authenticated by a RWE redemption server and can include a predetermined gambling outcome. The RWE client can receive a positive certificate authentication result requested from a RWE redemption server that confirms that the certificate is authentic. A game object wager payout can be produced based upon a positive certificate authentication result, which enables the RWE client to use the predetermined gambling outcome (including a random value and associated pay tables) based upon the game object gambling event occurrence (which can determine a particular pay table to be used with the random value) to generate a game object wager payout.

In a number of embodiments, a game object gambling event occurrence rule can detect a game object gambling event occurrence as any event that can occur within game object gambling hybrid game gameplay based upon a player action related to a game object. A game object gambling event occurrence can include, but is not limited to a player action that is a consumption of a particular element or a player action that achieves a combination of elements associated with a player profile.

In numerous embodiments, a game object wager execution rule can configure a real world engine to produce a game object wager payout from a game object wager of gameplay resources associated with a player profile in accordance with particular wager terms. In several embodiments, wager terms can dictate a particular pay table to be used with a random value generated by an RNG of a RWE to yield a game object wager payout. The wager terms can be based upon any aspect of game object gambling hybrid game gameplay, such as but not limited to a game object gambling event occurrence or gameplay resources associated with a player profile.

In numerous embodiments, a game object module can be implemented locally on a game object gambling hybrid game within the GWE, remotely on at least one server accessible to a game object gambling hybrid game via a network, or as a distributed system where processes of a game object module occur locally on a game object gambling hybrid game and on a remote server.

Game object gambling hybrid games in accordance with embodiments of the invention are discussed below.

### Game Object Gambling Hybrid Games

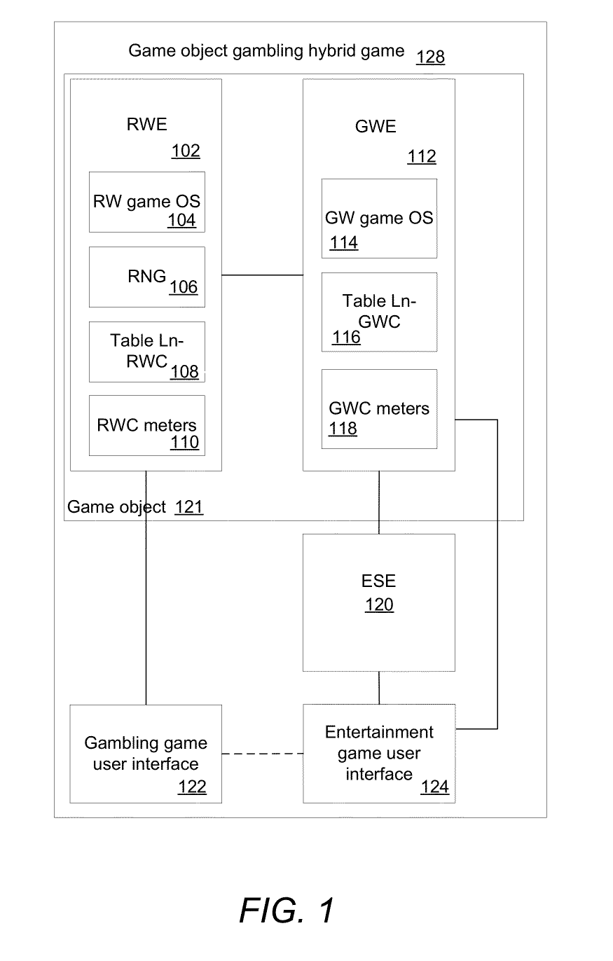

In many embodiments, a game object gambling hybrid game integrates high-levels of entertainment content with a game of skill (entertainment game) and a gambling experience with a game of chance (gambling game). A game object gambling hybrid game provides for random outcomes independent of player skill while providing that the user's gaming experience (as measured by obstacles/challenges encountered, time of play and other factors) is shaped by the player's skill. The game object gambling hybrid game can also utilize a game object module to generate a game object action that modifies entertainment game gameplay in response to a game object related player action. The game object action can be based upon a randomly generated game object wager payout from a game object wager in a gambling game triggered by the player action or based upon a predetermined gambling outcome. A game object gambling hybrid game in accordance with an embodiment of the invention is illustrated in FIG. 1. The game object gambling hybrid game 128 includes a game objection 121 including an RWE 102, and a GWE 112. The game object gambling hybrid game further includes an ESE 120 that uses the game object, a gambling game user interface 122 and an entertainment game user interface 124. The two user interfaces can be part of the same user interface but are separate in the illustrated embodiment. The RWE 102 is connected with the GWE 112 and optionally with the gambling game user interface 122. The ESE 120 is connected with the GWE 112 and the entertainment game user interface 124. The GWE 112 is optionally connected also with the entertainment game user interface 124.

In several embodiments, the RWE 102 is the operating system for the gambling game of the game object gambling hybrid game 128 and controls and operates the gambling game. The operation of a gambling game is enabled by RWC, such as money or other real world funds. A gambling game can increase or decreases an amount of RWC based on random gambling outcomes, where the gambling proposition of a gambling game is typically regulated by gaming control bodies. In many embodiments, the RWE includes a RW operating system (OS) 104, random number generator (RNG) 106, level n real-world credit pay tables (table Ln-RWC) 108, RWC meters 110 and other software constructs that enable a game of chance to offer a fair and transparent gambling proposition, and to contain the auditable systems and functions that can enable the game to obtain gaming regulatory body approval.

A random number generator (RNG) 106 includes software and/or hardware algorithms and/or processes, which are used to generate random outcomes. A level n real-world credit pay table (table Ln-RWC) 108 is a table that can be used in conjunction with a random number generator (RNG) 106 to dictate the real world credits (RWC) earned as a function of sponsored gameplay and is analogous to the pay tables used in a conventional slot machine. Table Ln-RWC payouts are independent of player skill. There can be one or a plurality of table Ln-RWC pay tables 108 contained in a gambling game, the selection of which can be determined by factors including (but not limited to) game progress a player has earned, and/or bonus rounds which a player can be eligible for. Real world credits (RWC) are credits analogous to slot machine game credits, which are entered into a gambling game by the user, either in the form of money such as hard currency or electronic funds. RWCs can be decremented or augmented based on the outcome of a random number generator according to the table Ln-RWC real world credits pay table 108, independent of player skill. In certain embodiments, an amount of RWC can be used as criteria in order to enter higher ESE game levels. RWC can be carried forward to higher game levels or paid out if a cash out is opted for by a player. The amount of RWC used to enter a specific level of the game level n need not be the same for each level.

In several embodiments, the GWE 112 includes an operating system (OS) 114 that provides control logic for the entertainment game. The GWE additionally contains a level n game world credit pay table (table Ln-GWC) 116 from where to take input from this table to affect the play of the entertainment game. The GWE 112 can further couple to the RWE 102 to determine the amount of RWC available on the game and other metrics of wagering on the gambling game (and potentially affect the amount of RWC in play on the RWE). The GWE additionally contains various audit logs and activity meters (such as the GWC meter) 118. The GWE 112 can also couple to a centralized server for exchanging various data related to the player and their activities on the game. The GWE 112 furthermore couples to the ESE 120.

In many embodiments, a level n game world credit pay table (Table Ln-GWC) 116 dictates the GWC earned as a function of player skill in the nth level of the game. The payouts governed by this table are dependent upon player skill and sponsored gameplay at large and can or cannot be coupled to a random number generator. In several embodiments, game world credits (GWC) are player points earned or depleted as a function of player skill, specifically as a function of player performance in the context of the game. GWC is analogous to the score in a typical video game. Each entertainment game has one or more scoring criterion, embedded within the table Ln-GWC 116 that reflects player performance against the goal(s) of the game. GWC can be carried forward from one level of sponsored gameplay to another, and ultimately paid out in various manners such as directly in cash, or indirectly such as by earning entrance into a sweepstakes drawing, or earning participation in, or victory in, a tournament with prizes. GWC can be stored on a player tracking card or in a network-based player tracking system, where the GWC is attributed to a specific player.

In certain embodiments, the operation of the GWE does not affect the RWE's gambling operation except for player choice parameters that are allowable in slot machines including but not limited to wager terms such as but not limited to a wager amount, how fast the player wants to play (by pressing a button or pulling the handle of a slot machine) and/or agreement to wager into a bonus round. In this sense, the RWE 102 provides a fair and transparent, non-skill based gambling proposition co-processor to the GWE 112. In the illustrated embodiment, the communication link shown between the GWE 112 and the RWE 102 allows the GWE 112 to obtain information from the RWE 102 as to the amount of RWC available in the gambling game. The communication link can also convey a status operation of the RWE (such as on-line or tilt). The communication link can further communicate the various gambling control factors which the RWE 102 uses as input, such as the number of RWC consumed per game or the player's election to enter a jackpot round. In FIG. 1, the GWE 112 is also shown as connecting to the player's user interface directly, as this can be utilized to communicate certain entertainment game club points, player status, control the selection of choices and messages which a player can find useful in order to adjust the entertainment game experience or understand their gambling status in the RWE 102.

In various embodiments, the ESE 120 manages and controls the visual, audio, and player control for the entertainment game. In certain embodiments, the ESE 120 accepts input from a player through a set of hand controls, and/or head, gesture, and/or eye tracking systems and outputs video, audio and/or other sensory output to a user interface. In many embodiments, the ESE 120 can exchange data with and accept control information from the GWE 112. In several embodiments an ESE 120 can be implemented using a personal computer (PC), a Sony PlayStation® (a video game console developed by Sony Computer Entertainment of Tokyo Japan), or Microsoft Xbox® (a video game console developed by Microsoft Corporation of Redmond, Wash.) running a specific entertainment game software program. In numerous embodiments, an ESE can be an electromechanical game system of a game object gambling hybrid game that is an electromechanical hybrid game. An electromechanical hybrid game executes an electromechanical game for player entertainment. The electromechanical game can be any game that utilizes both mechanical and electrical components, where the game operates as a combination of mechanical motions performed by at least one player or the electromechanical game itself. Various electromechanical hybrid games are discussed in Patent Cooperation Treaty Application No. PCT/US12/58156, filed Sep. 29, 2012, the contents of which are hereby incorporated by reference in their entirety.

The ESE 120, operates mostly independently from the GWE 112, except that via the interface, the GWE 112 can send certain entertainment game control parameters and elements to the ESE 120 to affect its play, such as (but not limited to) what level of character to be using, changing the difficulty level of the game, changing the type of gun or car in use, and/or requesting potions to become available or to be found by the character. These game control parameters and elements can be based on a gambling outcome of a gambling game that was triggered by an element in the entertainment game being acted upon by the player. The ESE 120 can accept this input from the GWE 112, make adjustments, and continue entertainment game gameplay all the while running seamlessly from the player's perspective. The ESE's operation is mostly skill based, except for where the ESE's processes can inject complexities into the game by chance in its normal operation to create unpredictability in the entertainment game. Utilizing this interface, the ESE 120 can also communicate player choices made in the game to the GWE 112, such as but not limited to selection of a different gun, and/or the player picking up a special potion in the GW environment. The GWE's job in this architecture, being interfaced thusly to the ESE 120, is to allow the transparent coupling of entertainment software to a fair and transparent random chance gambling game, providing a seamless perspective to the player that they are playing a typical popular entertainment game (which is skill based). In certain embodiments, the ESE 120 can be used to enable a wide range of entertainment games including but not limited to popular titles from arcade and home video games, such as but not limited to Gears of War (a third person shooter game developed by Epic Games of Cary, N.C.), Time Crisis (a shooter arcade game developed by Namco Ltd of Tokyo, Japan), or Madden Football (an American football video game developed by EA Tiburon of Maitland, Fla.). Providers of such software can provide the previously described interface by which the GWE 120 can request amendments to the operation of the ESE software in order to provide seamless and sensible operation as both a gambling game and an entertainment game.

In several embodiments, the RWE 102 can accept a trigger to run a gambling game in response to actions taken by the player in the entertainment game as conveyed by the ESE 120 to the GWE 112, or as triggered by the GWE 112 based on its algorithms, background to the overall game from the player's perspective, but can provide information to the GWE 112 to expose the player to certain aspects of the gambling game, such as (but not limited to) odds, amount of RWC in play, and amount of RWC available. The RWE 102 can accept modifications in the amount of RWC wagered on each individual gambling try, or the number of gambling games per minute the RWE 102 can execute, entrance into a bonus round, and other factors, all the while these factors can take a different form than that of a typical slot machine. An example of a varying wager amount that the player can choose can include but is not limited to gameplay with a more powerful character, a more powerful gun, or a better car. These choices can increase or decrease the amount wagered per individual gambling game, in the same manner that a standard slot machine player can decide to wager more or less credits for each pull of the handle. In several embodiments, the RWE 102 can communicate a number of factors back and forth to the GWE 112, via an interface, such increase/decrease in wager being a function of the player's decision making as to their operational profile in the entertainment game (such as but not limited to the power of the character, gun selection or car choice). In this manner, the player is always in control of the per game wager amount, with the choice mapping to some parameter or component that is applicable to the entertainment game experience of the hybrid game. In a particular embodiment, the RWE 102 operation can be a game of chance as a gambling game running every 10 seconds where the amount wagered is communicated from the GWE 112 as a function of choices the player makes in the operation profile in the entertainment game.

In many embodiments, a game object gambling hybrid game integrates a video game style gambling machine, where the gambling game (including an RWE 102 and RWC) is not player skill based, while at the same time allows players to use their skills to earn club points which a casino operator can translate to rewards, tournament opportunities and prizes for the players. The actual exchange of monetary funds earned or lost directly from gambling against a game of chance in a gambling game, such as a slot machine, is preserved. At the same time a rich environment of rewards to stimulate gamers can be established with the entertainment game. In several embodiments, the game object gambling hybrid game can leverage very popular titles with gamers and provides a sea change environment for casinos to attract players with games that are more akin to the type of entertainment that a younger generation desires. In various embodiments, players can use their skill towards building and banking GWC that in turn can be used to win tournaments and various prizes as a function of their gamer prowess. Numerous embodiments minimize the underlying changes needed to the aforementioned entertainment software for the hybrid game to operate within an entertainment game construct, thus making a plethora of complex game titles and environments, rapid and inexpensive to deploy in a gambling environment.

In certain embodiments, game object gambling hybrid games also allow players to gain entry into subsequent competitions through the accumulation of game world credits (GWC) as a function of the user's demonstrated skill at the game. These competitions can pit individual players or groups of players against one another and/or against the casino to win prizes based upon a combination of chance and skill. These competitions can be either asynchronous events, whereby players participate at a time and/or place of their choosing, or they can be synchronized events, whereby players participate at a specific time and/or venue.

In many embodiments, one or more players engage in playing an entertainment game, resident in the ESE, the outcomes of which are dependent at least in part on skill. The game object gambling hybrid game can include an entertainment game that includes head to head play between a single player and the computer, between two or more players against one another, or multiple players playing against the computer and/or each other, as well as the process by which players bet on the outcome of the entertainment game. The entertainment game can also be a game where the player is not playing against the computer or any other player, such as in games where the player is effectively playing against himself or herself (such as but not limited to Solitaire and Babette).

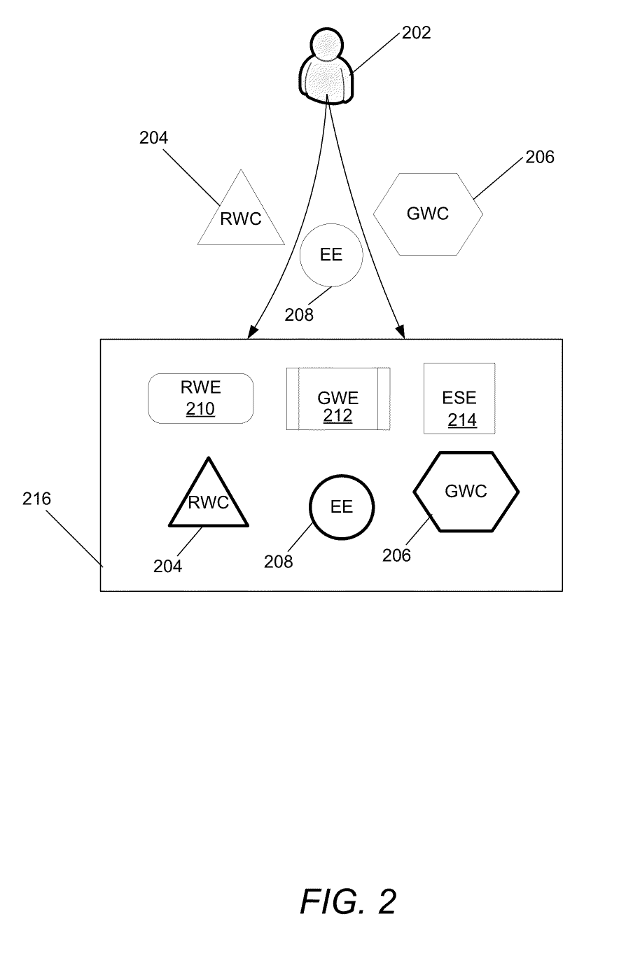

In several embodiments, a player can interact with a game object gambling hybrid game by using RWC in interactions with a gambling game along with GWC and elements in interactions with an entertainment game. The gambling game can be executed by a RWE while an entertainment game can be executed with an ESE and managed with a GWE. A conceptual diagram that illustrates how resources such as GWC, RWC and elements, such as but not limited to EE, are utilized in a game object gambling hybrid game in accordance with an embodiment of the invention is illustrated in FIG. 2. The conceptual diagram illustrates that RWC 204, EE 208 and GWC 206 can be utilized by a player 202 in interactions with the RWE 210, GWE 212 and ESE 214 of a game object gambling hybrid game 216. The contribution of elements, such as EE 208, can be linked to a player's access to credits, such as RWC 204 or GWC 206. Electronic receipt of these credits can come via a smart card, voucher or other portable media, or as received over a network from a server. In certain implementations, these credits can be drawn on demand from a player profile located in a database locally on a game object gambling hybrid game or in a remote server.

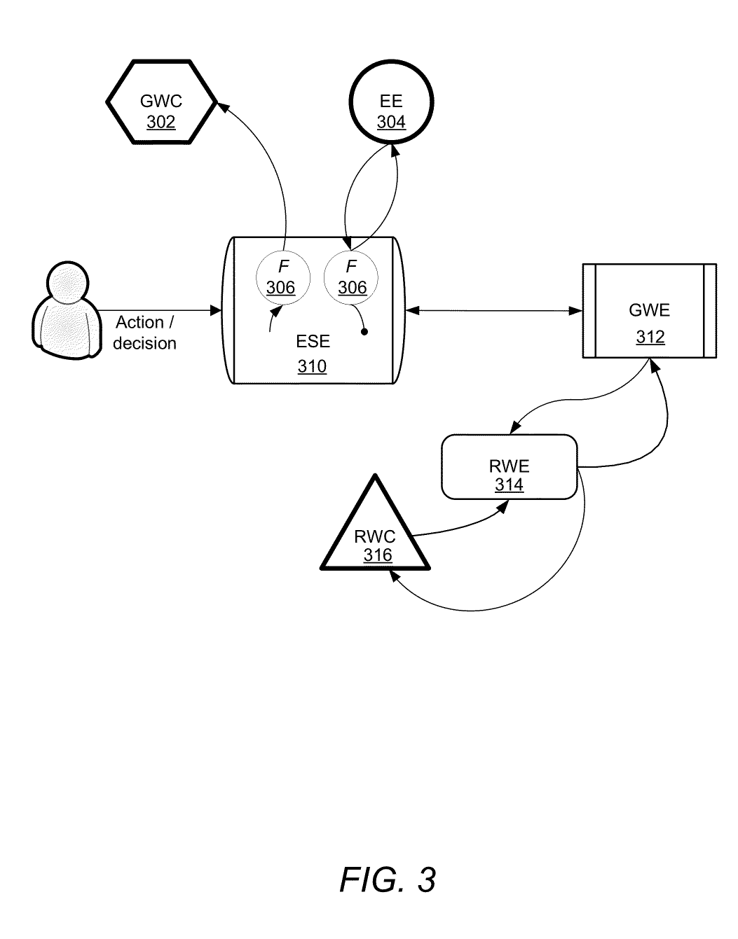

A conceptual diagram that illustrates interplay between elements and components of a game object gambling hybrid game in accordance with an embodiment of the invention is illustrated in FIG. 3. Similar to FIG. 2, a player's actions and/or decisions can affect functions 306 that consume and/or accumulate GWC 302 and/or EE 304 in an entertainment game executed by an ESE 310. A GWE 312 can monitor the activities taking place within an entertainment game executed by an ESE 310 for gameplay gambling event occurrences. The GWE 312 can also communicate the gameplay gambling event occurrences to an RWE 314 that triggers a wager of RWC 316 in a gambling game executed by the RWE 314.

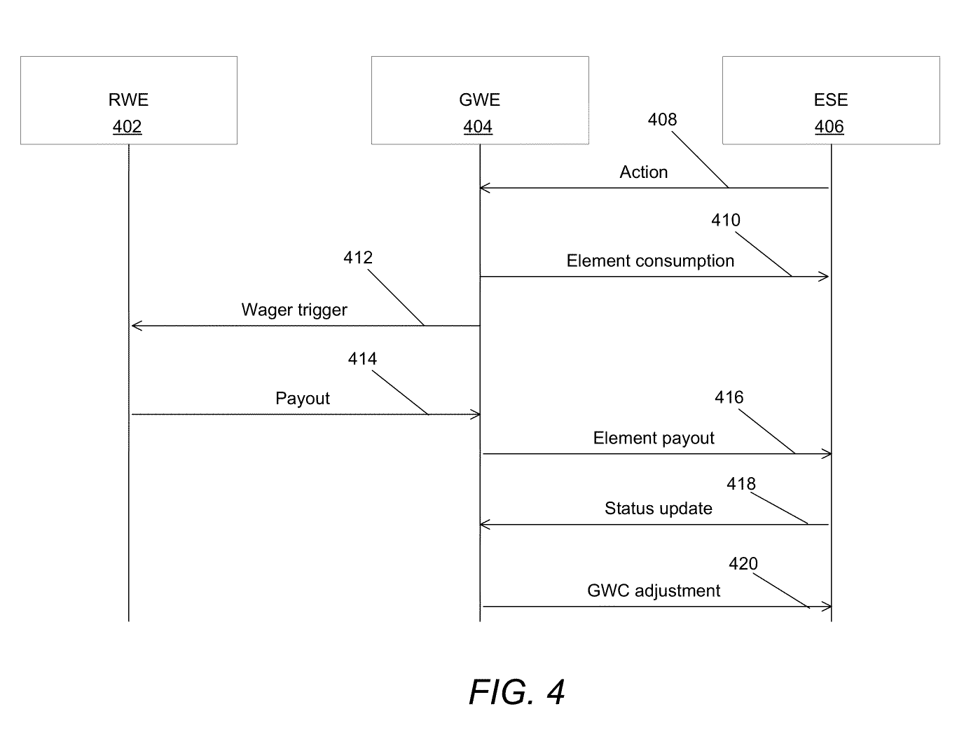

A timing diagram that illustrates a process of facilitating interactions between an entertainment game and a gambling game in accordance with embodiments of the invention is illustrated in FIG. 4. The process includes a player performing a player action using a user interface. An ESE 406 can signal (408) a GWE 404 of the player action. The GWE 404 can signal (410) the ESE 406 as to the amount of EE that will be consumed by the player action in return. The signal can configure a function that controls EE consumption, decay or addition for the ESE. The ESE 406 can, based upon the function, consume an amount of EE designated by the GWE 404 to couple to the activity. Upon detection that the player action is a gameplay gambling event, the GWE 404 can signal a RWE 402 as to the wager terms associated with the gameplay gambling event that triggers (412) a wager or the application of a predetermined gambling outcome. The RWE 402 can consume RWC in executing the wager. The RWE 402 can return RWC as a payout from the wager. The RWE 402 can inform (414) the GWE 404 as to the payout from the wager. The GWE 404 can signal (416) the ESE 406 to ascribe a payout of EE based upon the wager. The ESE 406 can reconcile and combine the payout of EE with the EE already ascribed to the player in the entertainment game. The ESE 406 can signal (408) the GWE 404 as to its updated status based upon reconciling the payout of EE, and the GWE 404 can signal the ESE 406 of a payout of GWC in response (420) to the status update.

In certain embodiments, the sequence of events in the timing diagram of FIG. 4 can be reflected in a first person shooter themed entertainment game. For example, a player can select a machine gun to use in an entertainment game and fires a burst at an opponent. The ESE can signal (408) the GWE of the player action, such as the player's choice of weapon, that a burst of fire was fired, and the outcome of whether the player hit the opponent with the burst of fire. The GWE can process the information concerning the machine gun burst, and signal (410) the ESE to consume 3 bullets (EE) with each pull of the trigger. The entertainment game then will consume 3 bullets (EE) based upon the trigger being pulled. The GWE can also signal (412) the RWE that 3 credits of RWC are to be wagered to match the 3 bullets (EE) consumed, on a particular pay table (Table Ln-RC) as a function how much damage the player inflicted on his/her opponent. The RWE can consume the 3 credits for the wager and execute the specified wager. In executing the wager, the RWE can determine that the player hits a jackpot of 6 credits, and return the 6 credits of RWC to the credit meter. The RWE can also inform (414) the GWE that 3 credits of RWC net were won as a payout from the wager. The GWE can signal (416) the ESE to add 3 bullets (EE) to the player's ammunition clip based upon the gambling game payout. The ESE can then add 3 bullets (EE) to the player's ammunition clip in the entertainment game. This can take place by directly adding them to the clip, or can happen in the context of the entertainment game, such as the player finding extra ammunition on the ground or in an old abandoned ammunition dump. The GWE can receive (418) an update from the ESE as to the total amount of EE associated with the player. The GWE can log the new player score (GWC) in the game (as a function of the successful hit on the opponent) based on the update, and signal (420) the ESE to add 2 extra points of GWC to the player's score.

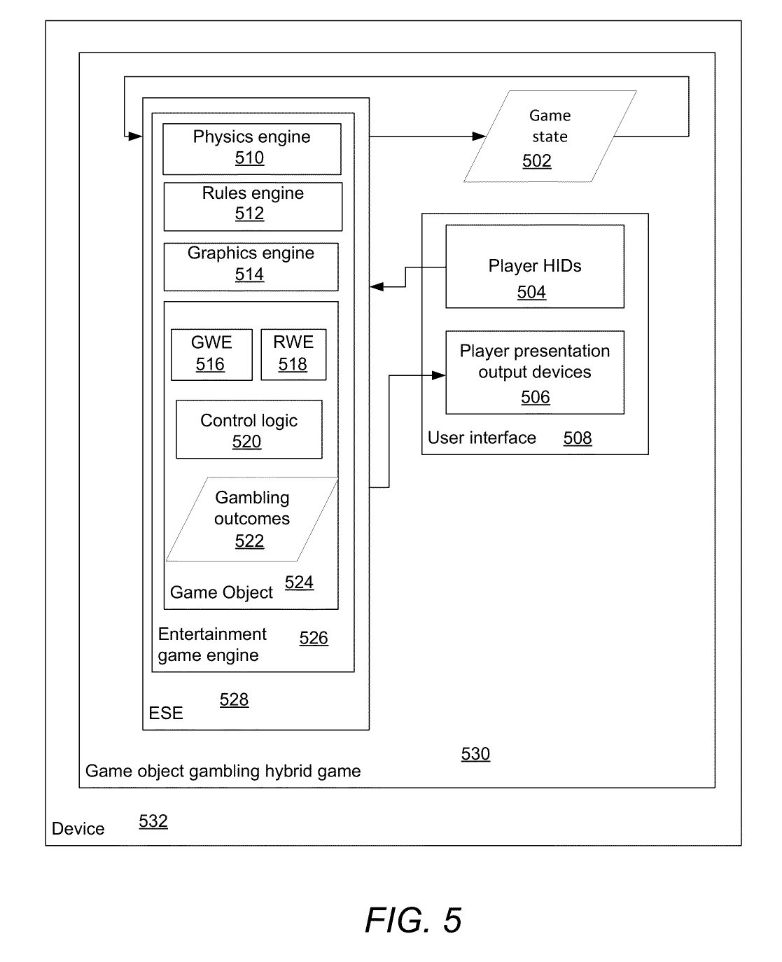

A conceptual diagram that illustrates various components of a game object gambling hybrid game in accordance with an embodiment of the invention is illustrated in FIG. 5. The conceptual diagram illustrates that a device 532 can provide hardware on which the game object gambling hybrid game 530 can execute. The game object gambling hybrid game can include an ESE 528 that utilizes an entertainment game engine 526 to execute an entertainment game. The ESE 502 can reference stored game state information 502 that describes at least one game state which can be used by the ESE 528 in generating an entertainment game. The ESE 528 can also interact with a user interface 508 that includes player presentation output devices 506 that can provide audio, visual or tactile information concerning the entertainment game (such as but not limited to a screen that provides information concerning a player's entertainment game gameplay progression) and human input devices (HIDs) 504 in which a player can interact with a game object gambling hybrid game.

In several embodiments, the entertainment game engine can include various components that facilitate the effective execution of the entertainment game, such as but not limited to a physics engine 510, rules engine 512, graphics engine 514 and at least one game object 524 which can be referenced by the entertainment game engine 526 during the execution of the entertainment game. The physics engine 510 can be used to simulate physical interactions within an entertainment game. The rules engine 512 can be used to implement rules within entertainment game gameplay which govern how an entertainment game can be implemented. A graphics engine 514 can be used to generate a representation of physical interactions within the virtual world of the entertainment game. The game object 524 can have entertainment game control logic 520 that determines how the game object can behave within the context of an entertainment game, such as but not limited to the types of game object actions that the game object can generate based upon player actions related to the game object. In numerous embodiments, an ESE can utilize multiple game engines that can execute an entertainment game. In certain embodiments, an ESE can be integrated with a single entertainment game engine. In particular embodiments, a generic game engine can be utilized with a game object to implement a game object gambling hybrid game.

In a number of embodiments, a game object can call upon services of a GWE or RWE to implement a game object gambling hybrid game. In various embodiments, the services of a GWE or RWE can be called upon by communicating with a GWE or RWE from the game object, such as but not limited to by using an API or a socket to communicate with a GWE or RWE. In certain embodiments, a GWE or RWE client can be used by a game object to facilitate communicate with servers which perform certain services of a GWE or RWE. The RWE can have access to predetermined gambling outcomes, which can be stored locally with the game object or be utilized by the RWE at a location separate than the location at which the ESE is located. In certain embodiments, the RWE used by a game object can generate a game object wager payout using one or more predetermined gambling outcomes that are stored in the game object or acquired by the game object during the play of the game. In many embodiments, a predetermined gambling outcome is information generated by a RWE that can be utilized to generate a game object wager payout set prior to triggering execution of the game object wager for the game object wager payout, such as but not limited to a random value generated by a RNG of a RWE. The random value can be configured to be utilized with a pay table to determine a game object wager payout. In a variety of embodiments, a predetermined gambling outcome can include both a random value generated by an RNG of a RWE along with an associated pay table that is to be utilized to interpret the random value to generate a game object wager payout.

In many embodiments, if an entertainment game employs an American football themed entertainment game, a player can bet on whether or not a player will beat another player. These bets can be made, for example, on the final outcome of the game, and/or the state of the game along various intermediary points (such as but not limited to the score at the end of the 1st quarter) and/or on various measures associated with the game (such as but not limited to the total offensive yards, number of turnovers, or number of sacks). Players can bet against one another, or engage the computer in a head to head competition in the context of their skill level in the entertainment game in question. As such, players can have a handicap associated with their player profile that describes their skill (which can be their professed skill in certain embodiments), and which is used by a GWE (such as a local GWE or a GWE that receives services from remote servers) to offer appropriate bets around the final and/or intermediate outcomes of the entertainment game, and/or to condition sponsored gameplay as a function of player skill, and/or to select players across one or more game object gambling hybrid games to participate in head to head games and/or tournaments.

Many embodiments enable the maximization of the number of players able to compete competitively by enabling handicapping of players by utilizing a skill normalization module that handicaps players to even the skill level of players competing against each other. Handicapping enables players of varying performance potential to compete competitively regardless of absolute skill level, such as but not limited to where a player whose skill level identifies the player as a beginner can compete in head to head or tournament play against a highly skilled player with meaningful results.

In several embodiments, wagers can be made among numerous game object gambling hybrid games with a global betting manager (GBM). The GBM is a system that coordinates wagers that are made across multiple game object gambling hybrid games by multiple players. In some implementations it can also support wagers by third parties relative to the in game performance of other players. The GBM can stand alone, or is capable of being embedded in one of a number of systems, including a GWE, ESE or any remote server capable of providing services to a game object gambling hybrid game, or can operate independently on one or a number of servers on-site at a casino, as part of a larger network and/or the Internet or cloud in general.

Although various components of game object gambling hybrid games are discussed above, game object gambling hybrid games can be configured with any component as appropriate to the specification of a specific application in accordance with embodiments of the invention. In certain embodiments, components of a game object gambling hybrid game, such as a GWE, RWE, ESE can be configured in different ways for a specific game object gambling hybrid game gameplay application. Network connected game object gambling hybrid games are discussed below.

### Network Connected Game Object Gambling Hybrid Games

Game object gambling hybrid games in accordance with many embodiments of the invention can operate locally while being network connected to draw services from remote locations or to communicate with other game object gambling hybrid games. In many embodiments, operations associated with a game object gambling hybrid game utilizing a game object module can be performed across multiple devices. These multiple devices can be implemented using a single server or a plurality of servers such that a game object gambling hybrid game is executed as a system in a virtualized space, such as (but not limited to) where the RWE and GWE are large scale centralized servers in the cloud coupled to a plurality of widely distributed ESE controllers or clients via the Internet.

In many embodiments, an RWE server can perform certain functionalities of a RWE of a game object gambling hybrid game. In certain embodiments, a RWE server includes a centralized odds engine which can generate random outcomes (such as but not limited to win/loss outcomes) for a gambling game. The RWE server can perform a number of simultaneous or pseudo-simultaneous runs in order to generate random outcomes for a variety of odds percentages that one or more networked game object gambling hybrid games can use. In certain embodiments, an RWE of a game object gambling hybrid game can send information to a RWE server including (but not limited to) table Ln-RWC tables, maximum speed of play for a gambling game, gambling game monetary denominations or any promotional RWC provided by the operator of the game object gambling hybrid game. In particular embodiments, a RWE server can send information to a RWE of a game object gambling hybrid game including (but not limited to) RWC used in the gambling game, player profile information or play activity and a profile associated with a player.

In several embodiments, a GWE server can perform the functionality of the GWE across various game object gambling hybrid games. These functionalities can include (but are not limited to) providing a method for monitoring high scores on select groups of games, coordinating interactions between gameplay layers, linking groups of games in order to join them in head to head tournaments, and acting as a tournament manager.

In a variety of embodiments, management of player profile information can be performed by a patron management server separate from a GWE server. A patron management server can manage information related to a player profile, including (but not limited to) data concerning controlled entities (such as characters used by a player in entertainment game gameplay), game scores, elements, RWC and GWC associated with particular players and managing tournament reservations. Although a patron management server is discussed separate from a GWE server, in certain embodiments a GWE server also performs the functions of a patron management server. In certain embodiments, a GWE of a game object gambling hybrid game can send information to a patron management server including (but not limited to) GWC and RWC used in a game, player profile information, play activity and profile information for players and synchronization information between a gambling game and an entertainment game or other aspects of a game object gambling hybrid game. In particular embodiments, a patron management server can send information to a GWE of a game object gambling hybrid game including (but not limited to) entertainment game title and type, tournament information, table Ln-GWC tables, special offers, character or profile setup and synchronization information between a gambling game and an entertainment game or other aspects of a game object gambling hybrid game.

In numerous embodiments, an ESE server provides a host for managing head to head play, operating on the network of ESEs which are connected to the ESE server by providing an environment where players can compete directly with one another and interact with other players. Although an ESE server is discussed separate from a GWE server, in certain embodiments the functionalities of an ESE server and GWE server can be combined in a single server.

In several embodiments, a game object server can be connected with a game object gambling hybrid game and can implement a game object module to coordinate the activities of a game object gambling hybrid game. A game object module can execute as part of a game object server to generate a game object action that modifies entertainment game gameplay in response to a game object related player action. The game object action can be based upon a randomly generated game object wager payout from a game object wager in a gambling game triggered by the player action.

Servers connected via a network to implement game object gambling hybrid games in accordance with many embodiments of the invention can communicate with each other to provide services utilized within a game object gambling hybrid game. In several embodiments a RWE server can communicate with a GWE server. A RWE server can communicate with a GWE server to communicate any type of information as appropriate for a specific application, including (but not limited to): information used to configure the various simultaneous or pseudo simultaneous odds engines executing in parallel within the RWE to accomplish game object gambling hybrid game system functionalities, information used to determine metrics of RWE performance such as random executions run and outcomes for tracking system performance, information used to perform audits, provide operator reports, and information used to request the results of a random run win/loss result for use of function operating within the GWE (such as where automatic drawings for prizes are a function of ESE performance), and/or predetermined gambling outcomes.

In several embodiments a GWE server can communicate with an ESE server. A GWE server can communicate with an ESE server to communicate any type of information as appropriate for a specific application, including (but not limited to): the management of an ESE server by a GWE server during a game object gambling hybrid game tournament. Typically a GWE (such as a GWE that runs within a game object gambling hybrid game or on a GWE server) is not aware of the relationship of itself to the rest of a tournament since in a typical configuration the actual tournament play is managed by the ESE server. Therefore, management of a game object gambling hybrid game tournament can include (but is not limited to) tasks such as: conducting tournaments according to system programming that can be coordinated by an operator of the game object gambling hybrid game; allowing entry of a particular player into a tournament; communicating the number of players in a tournament and the status of the tournament (such as but not limited to the amount of surviving players, their status within the game, time remaining on the tournament); communicating the performance of its players within the tournament; communicating the scores of the various members in the tournament; and providing a synchronizing link to connect the GWEs in a tournament with their respective ESE's.

In several embodiments a GWE server can communicate with a patron management server. A GWE server can communicate with a patron management server to communicate any type of information as appropriate for a specific application, including (but not limited to) information for configuring tournaments according to system programming conducted by an operator of a game object gambling hybrid game, information for exchange of data used to link a player's player profile to their ability to participate in various forms of sponsored gameplay (such as but not limited to the difficulty of play set by the GWE server or the GWE), information for determining a player's ability to participate in a tournament as a function of a player's characteristics (such as but not limited to a player's gaming prowess or other metrics used for tournament screening), information for configuring GWE and ESE performance to suit preferences of a player on a particular game object gambling hybrid game, information for determining a player's play and gambling performance for the purposes of marketing intelligence, and information for logging secondary drawing awards, tournament prizes, RWC and GWC into the player profile.

In many embodiments, the actual location of where various algorithms and functions are executed can be located either in the game contained devices (RWE, GWE, ESE), on the servers (RWE server, GWE server, or ESE server), or a combination of both game contained devices and servers. In particular embodiments, certain functions of a RWE server, GWE server, patron management server or ESE server can operate on the local RWE, GWE or ESE contained with a game object gambling hybrid game locally. In certain embodiments, a server can be part of a server system including a plurality of servers, where software can be run on one or more physical devices. Similarly, in particular embodiments, multiple servers can be combined on a single physical device.

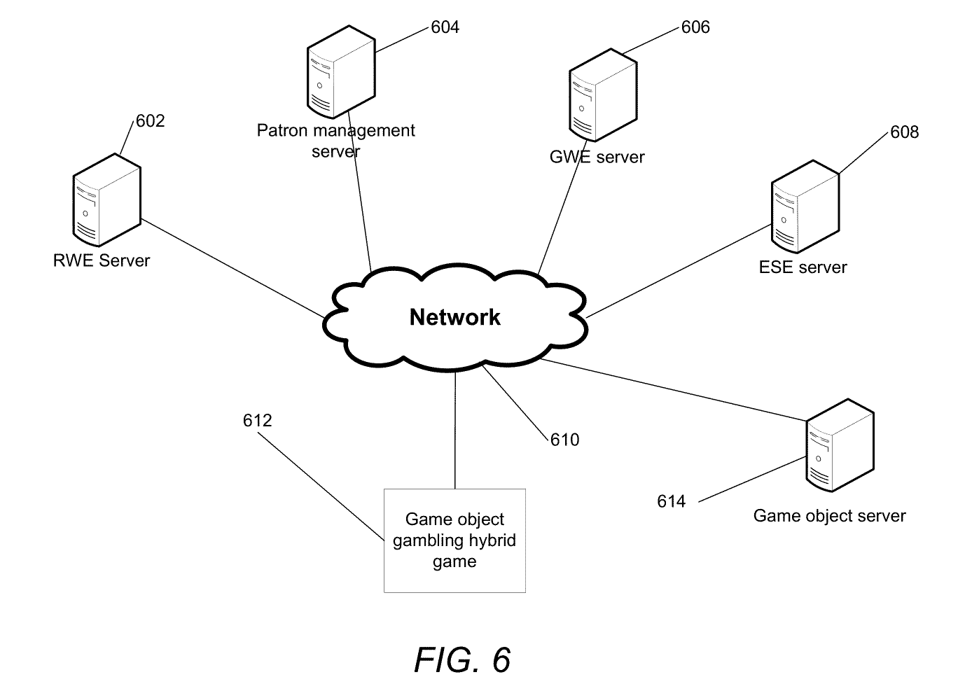

Game object gambling hybrid games in accordance with many embodiments of the invention can be networked with remote servers in various configurations. A networked game object gambling hybrid game in accordance with an embodiment of the invention is illustrated in FIG. 6. The networked game object gambling hybrid game 612 is connected with a RWE server 602, patron management server 604, GWE server 606, ESE server 608 and a game object server 614 over a network 610, such as (but not limited to) the Internet. Servers networked with a networked game object gambling hybrid game 612 can also communicate with each of the components of a networked game object gambling hybrid game and amongst the other servers in communication with the networked game object gambling hybrid game 612.

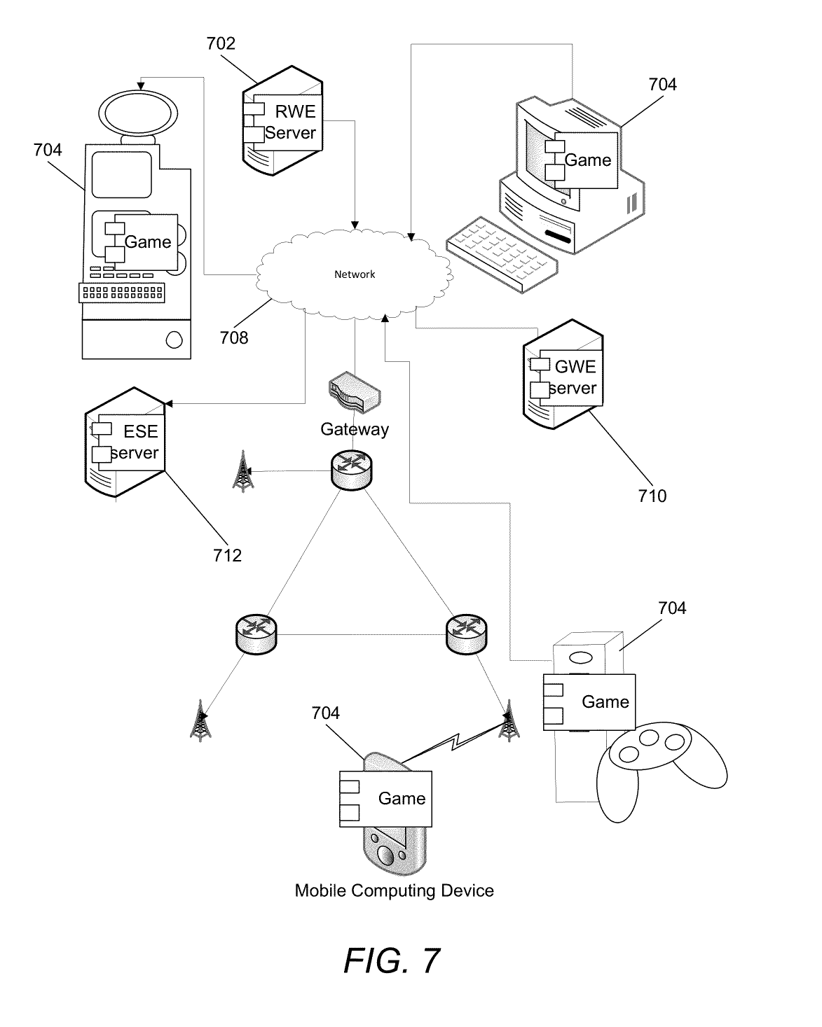

A system diagram that illustrates an implementation of a network distributed game object gambling hybrid game with a local device user interface in accordance with an embodiment of the invention is illustrated in FIG. 7. The system diagram illustrates that various network connected game object gambling hybrid games 704 can be connected to a network 708 to draw upon services from a RWE server 702, GWE server 710 or an ESE server 712. The network can be a wired or a wireless network. Each game object gambling hybrid game can be implemented on any network connected device, such as but not limited to a smart phone, a personal digital assistant (PDA), a tablet computer, gambling machine, general purpose computer or a gambling console.

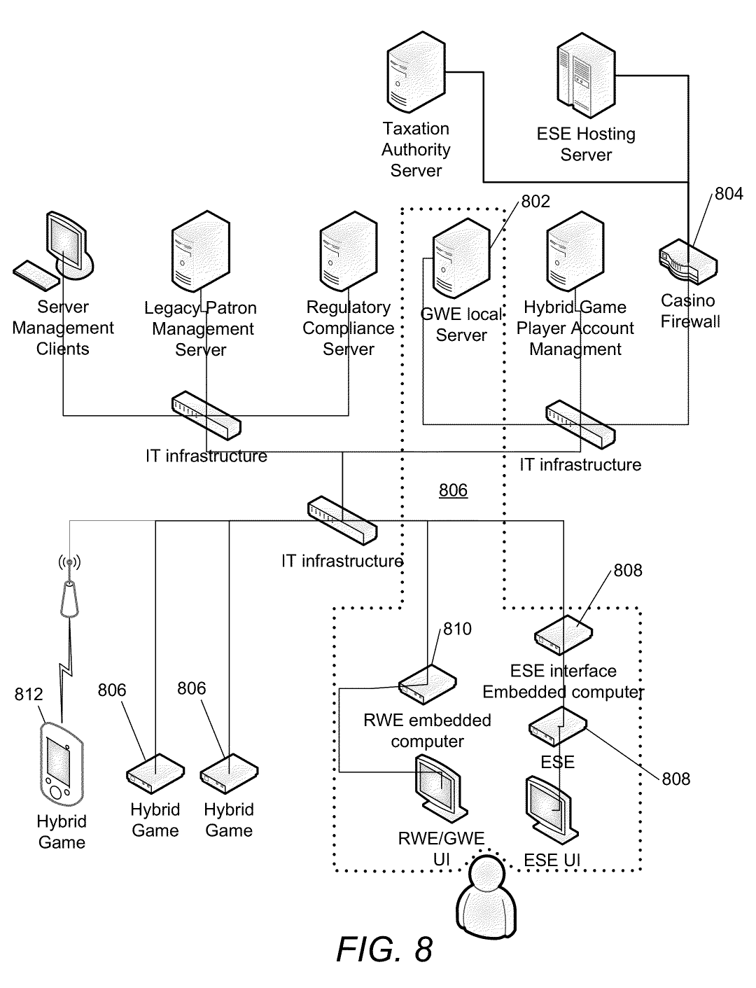

A system diagram that illustrates an implementation of a network distributed game object gambling hybrid game with a GWE local server in accordance with an embodiment of the invention is illustrated in FIG. 8. The system includes several game object gambling hybrid games 806 sharing services from the same GWE local server 802 over a network. The several game object gambling hybrid games can be implemented on any device, including laptops, desktop computers, mobile phones, tablets 812 over a wireless connection. A single game object gambling hybrid game 806 with a RWE 810, ESE 808 and GWE 802 is enclosed within a dotted line. A number of other peripheral systems, such as player management, casino management, regulatory, and hosting servers can also interface with the game object gambling hybrid games over a network within an operator's firewall 804. Also, other servers can reside outside the bounds of a network within an operator's firewall 804 to provide additional services for network connected game object gambling hybrid games.

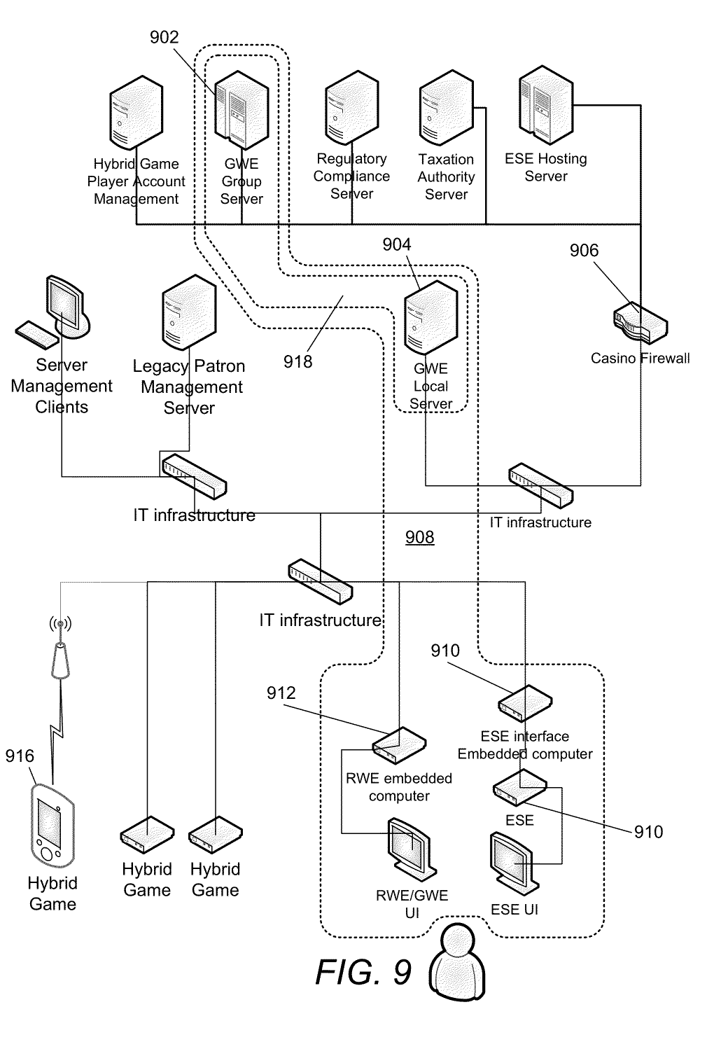

A system diagram that illustrates an implementation of a network distributed hybrid game with a GWE local server and a GWE group server in accordance with an embodiment of the invention is illustrated in FIG. 9. This system includes a game object gambling hybrid game with a RWE 912, ESE 910 and GWE local server 904 enclosed within a dotted line but where a single hybrid game can call upon services from servers within an operator's firewall 906 (such as but not limited to a GWE local server) as well as beyond an operator's firewall 906 (such but not limited to a GWE group server 902). The GWE group server 902 can coordinate multiple game object gambling hybrid games from across a network that spans beyond an operator's firewall 906. A GWE server system 918 can include multiple GWE servers, such as but not limited to a GWE local server 904 and a GWE group server 902. Multiple network connected hybrid games can be implemented using various computing devices 916 (such as but not limited to laptops, desktop computers, mobile phones, PDAs or tablets) and be connected to various servers to call upon services that enable the execution of the hybrid game.

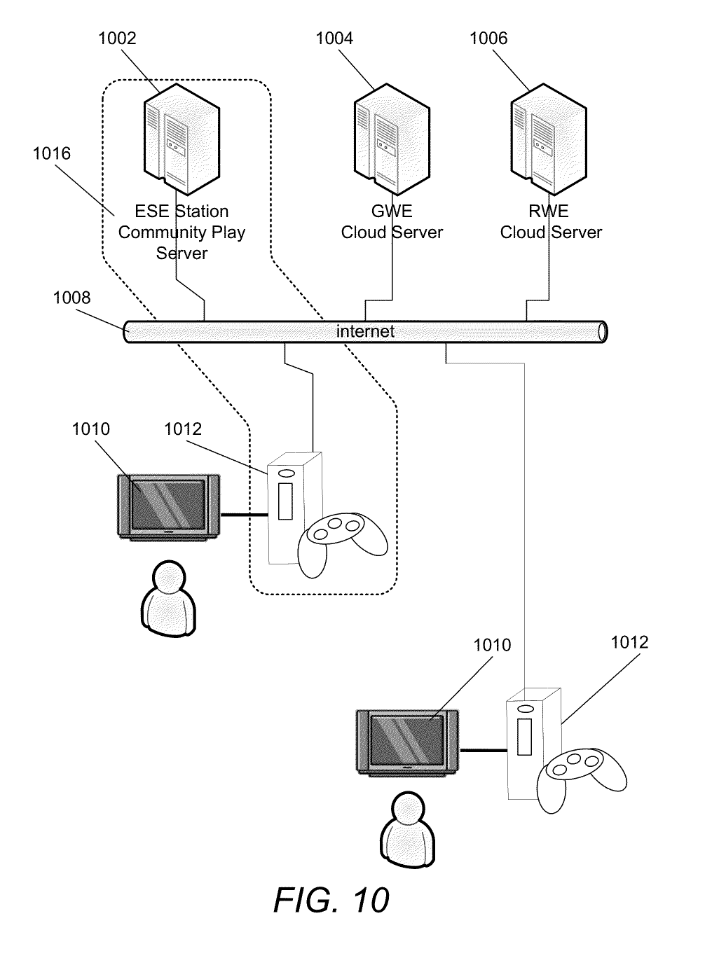

A system diagram that illustrates an implementation of network distributed hybrid games over the Internet in accordance with an embodiment of the invention is illustrated in FIG. 10. The system includes an ESE server 1002, GWE server 1004 and RWE server 1006 that connects to a user interface 1010 (such as but not limited to a television screen, computer terminal, tablet, touchscreen or PDA) of game object gambling hybrid games over the Internet 1008. Each game object gambling hybrid game includes a local ESE 1012 that also interfaces with a remote ESE server 1002. Processes performed by an ESE 1016 services can be performed in multiple locations, such as but not limited to remotely on an ESE server 1002 and locally on a local ESE 1012.

Although various networked game object gambling hybrid games are discussed above, game object gambling hybrid games can be networked in any configuration as appropriate to the specification of a specific application in accordance with embodiments of the invention. In certain embodiments, components of a networked game object gambling hybrid game, such as a GWE, RWE, ESE or servers that perform services for a GWE, RWE or ESE, can be networked in different configurations for a specific networked game object gambling hybrid game gameplay application. Game object modules are discussed below.

### Game Object Modules

Game object modules in accordance with many embodiments of the invention can generate a game object action that modifies entertainment game gameplay in response to a game object related player action. The game object action can be based upon a randomly generated game object wager payout from a game object wager in a gambling game triggered by player action with respect to a game object. In several embodiments, a game object is an object that a player can interact within during entertainment game gameplay progression. A game object can be utilized in a modular fashion in an entertainment game with its own GWE and RWE functionalities, such as but not limited to executing specific game object wagers in accordance with a game object wager execution rule associated with the game object. In certain embodiments with a shooter themed entertainment game, a game object that is a machine gun may have a specific associated gambling game, while a game object that is a hand gun may have a different associated gambling game. Similarly in an adventure themed entertainment game, each game object (such as but not limited to a sword, bow, mace or axe) may each have different associated gambling games. A player can produce a player action related to the game object, such as but not limited to picking up a game object or using a game object. A player action, or a combination of player actions related to the game object may be determined as part of a game object gambling event occurrence to trigger a game object wager. In several embodiments, each game object may have a GWE (as opposed to a centralized GWE that monitors the entertainment game) that coordinates communication between an entertainment game executed by an ESE and a gambling game executed by the RWE. In several embodiments, a game object may yield an associated game object wager payout in the form of gameplay resources (such as but not limited to elements, RWC or GWC) and may also generate a game object action based upon the game object wager payout (such as but not limited to the amount of damage that is inflicted upon using a game object that is a gun based upon the randomly generated game object wager payout).

In numerous embodiments, the game object wager execution rule may execute a game object wager to generate a game object wager payout using predetermined gambling outcomes. In many embodiments, a predetermined gambling outcome is information generated by a RWE that can be utilized to generate a game object wager payout set prior to triggering execution of the game object wager for the game object wager payout, such as but not limited to a random value generated by a RNG of a RWE. The random value may be configured to be utilized with a pay table to determine a game object wager payout. In a variety of embodiments, a predetermined gambling outcome may include both a random value generated by an RNG of a RWE along with an associated pay table that is to be utilized to interpret the random value to generate a game object wager payout. A game object wager payout may be determined by interpreting the random value generated from an RNG in the context of an associated pay table. In certain embodiments, the associated pay table may be determined at a point in time after the generation of the randomly generated value from an RNG, such as but not limited to upon triggering execution of a game object wager. A game object wager execution rule can determine how a pay table is used for a game object wager payout based upon factors such as but not limited to a particular game object gambling event occurrence, the identity of a player, the identity of an associated game object or entertainment game gameplay progression. In certain embodiments, an amount of stored predetermined gambling outcomes may be generated for storage at arbitrary intervals, such as but not limited to when the amount of stored predetermined gambling outcomes falls below a threshold or after the elapse of a particular amount of time.

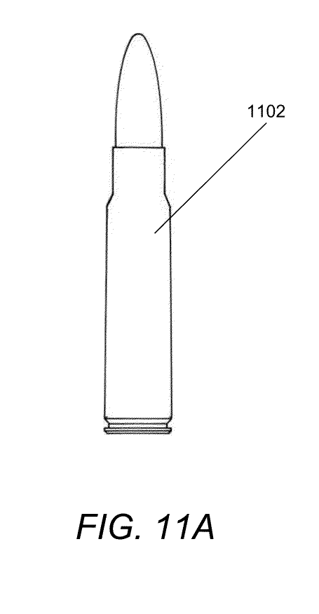

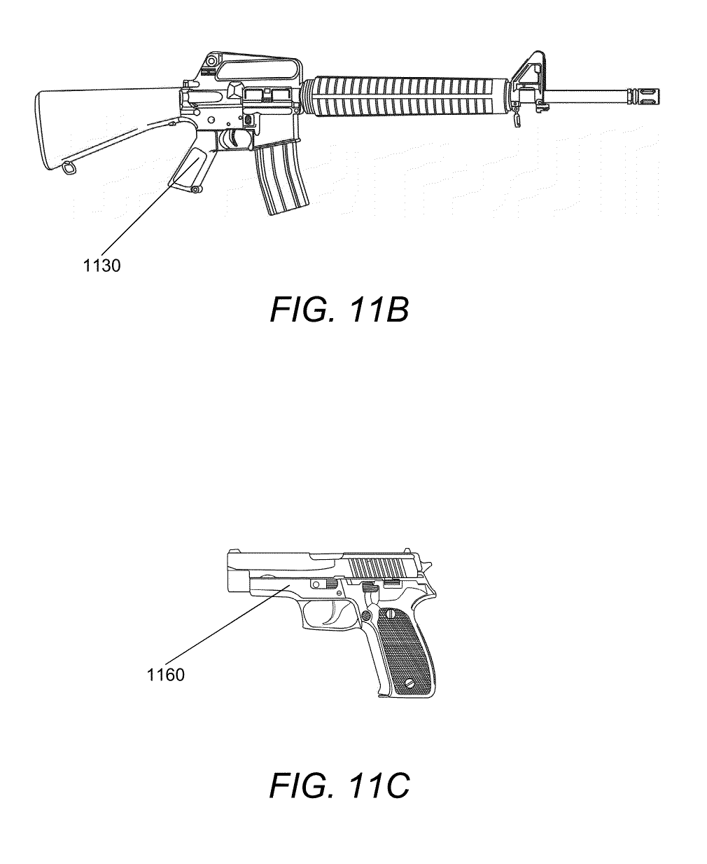

In numerous embodiments, a game object may fill the role of an element that is consumed or configured in order to progress entertainment game gameplay, such as but not limited to an EE. A conceptual diagram that illustrates an image of a bullet utilized in a game object gambling hybrid game representative of a game object in accordance with an embodiment of the invention is illustrated in FIG. 11A. The image representing a bullet 1102 as a game object can be presented to a user in a user interface of a game object gambling hybrid game as a game object that a player can interact with. The bullet 1102 may also be utilized as an EE that a player can consume to progress through entertainment game gameplay, such as but not limited to by shooting the bullet 1102 to attack an enemy. A specific predetermined gambling outcome may be associated with each bullet that can be utilized in an entertainment game. Each predetermined gambling outcome may include a random number generated from an RNG along with an associated pay table. One or more of these predetermined gambling outcomes may be exposed to a player in a game object wager payout as each bullet 1102 is consumed in a game object gambling event occurrence to trigger a game object wager. Thereby, a game object wager that utilizes a predetermined gambling outcome does not need to utilize a RWE to generate a game object wager payout upon occurrence of the game object gambling event occurrence but rather can utilize a predetermined gambling outcome to determine the game object wager payout. In certain embodiments, each game object acquired by a player in an entertainment game may include predetermined gambling outcomes associated with the game object. In particular embodiments with a shooting themed entertainment game, each of an arbitrary number of bullets (game objects) acquired by a player may have an associated predetermined gambling outcome associated with each bullet. The predetermined gambling outcomes may be exposed to a player in a game object wager payout upon the player consuming (such as but not limited to by shooting) the bullet to further entertainment game gameplay.

In various embodiments, a player may configure a game object to interact with other game objects. A conceptual diagram that illustrates an image of a machine gun utilized in a game object gambling hybrid game representative of a game object in accordance with an embodiment of the invention is illustrated in FIG. 11B. The image may be presented in a user interface as a game object representing a machine gun 1130 as a game object within a user interface, which a player can use to interact with other game objects, such as but not limited to bullets that can be utilized by the machine gun to attack an enemy. In a variety of embodiments, different game objects may interact with a same game object in different ways. A conceptual diagram that illustrates an image of a hand gun utilized in a game object gambling hybrid game representative of a game object in accordance with an embodiment of the invention is illustrated in FIG. 11C. The image may be presented in a user interface as a game object representing a hand gun 1160 within a user interface which a player can use to interact with other game objects, such as but not limited to bullets. However, the bullet illustrated in FIG. 11A can be different than the type of bullet that can be utilized by the hand gun in FIG. 11C.

Although various game object modules are discussed above, game object gambling hybrid games can utilize game object modules in any configuration as appropriate to the specifications of a specific application in accordance with embodiments of the invention. Game object module implementations are discussed below.

### Game Object Management

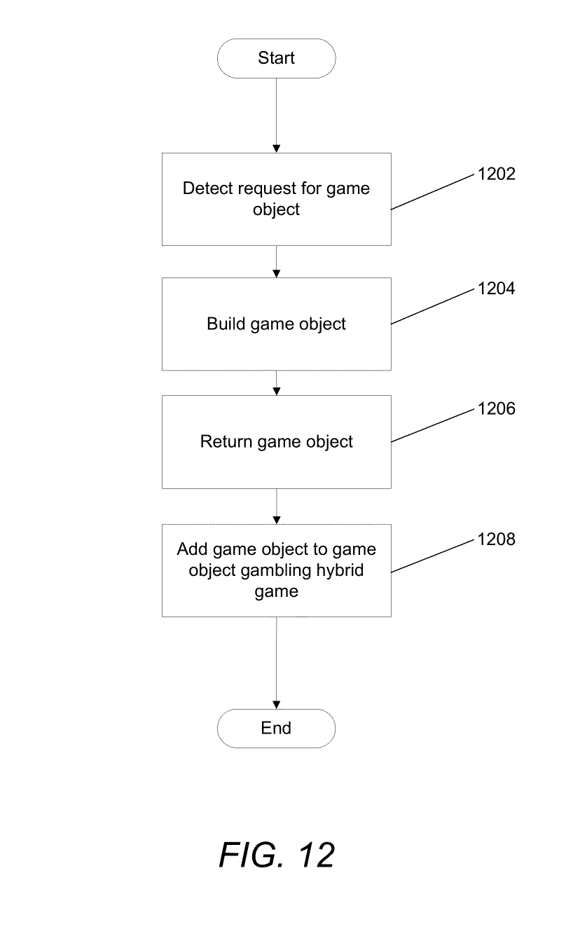

In several embodiments, an entertainment game can be configured with multiple game objects that a player can interact with during entertainment game gameplay. These game objects can be generated and integrated with an entertainment game during entertainment game configuration. A flow chart of a process for adding a game object to a game object gambling hybrid game in accordance with an embodiment of the invention is illustrated in FIG. 12. The process includes detecting (1202) a request for a game object during entertainment game configuration. A game object can be built (1204) in accordance with a request for a game object, such as but not limited to configuring aspects of the game object based upon the request for the game object. A game object can be built locally on a device that hosts the game object gambling hybrid game or on a specialized device constructed to build a game object, such as but not limited to a game object server. A built game object can be returned (1206) for integration by adding (1208) the game object to an entertainment game.

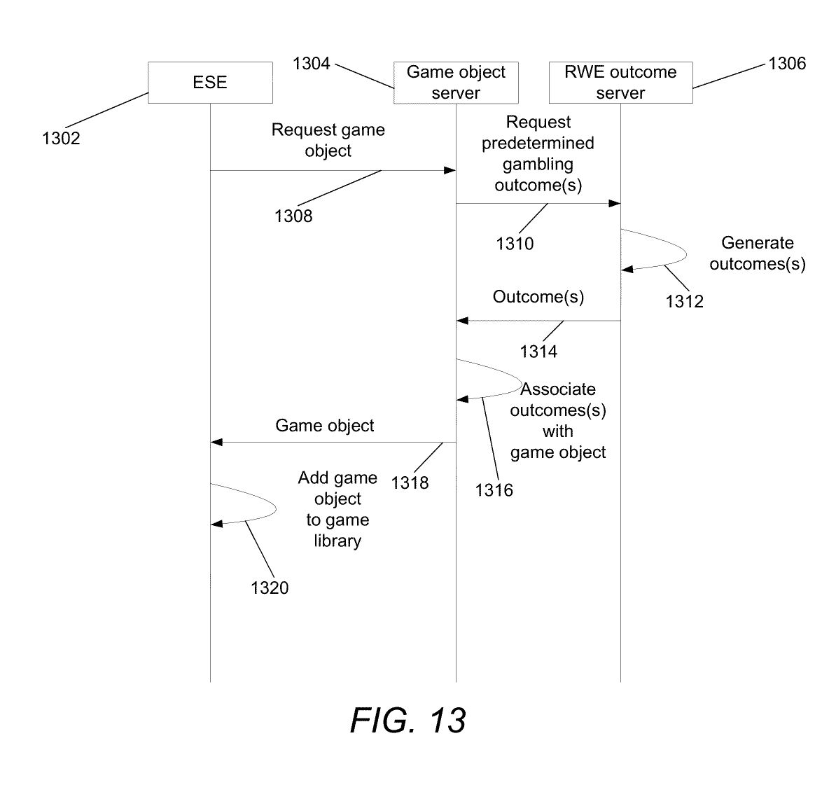

A timing diagram of a process for adding a game object to a game object gambling hybrid game in accordance with an embodiment of the invention is illustrated in FIG. 13. The timing diagram illustrates that an ESE 1302 can be used to configure an entertainment game with at least one game object. In configuring the entertainment game, a game object can be requested (1308) from a game object server 1304. The game object server 1304 can begin to build the game object by requesting (1310) a number of predetermined gambling outcomes generated (1312) from an RWE outcome server. The RWE outcome server 1306 can include a RNG that provides a random value that can be associated with a pay table. A number of the predetermined gambling outcomes can be returned (1314) to the game object server 1304 and added to a game object in building the game object. Once a game object is built by being associated (1316) with predetermined gambling outcomes, the game object can be returned (1318) to an ESE 1302 and added (1320) to a library of game objects available to an entertainment game. In certain embodiments, a game object server can also incorporate the functionalities of a RWE outcome server in generating a random value using a RNG.

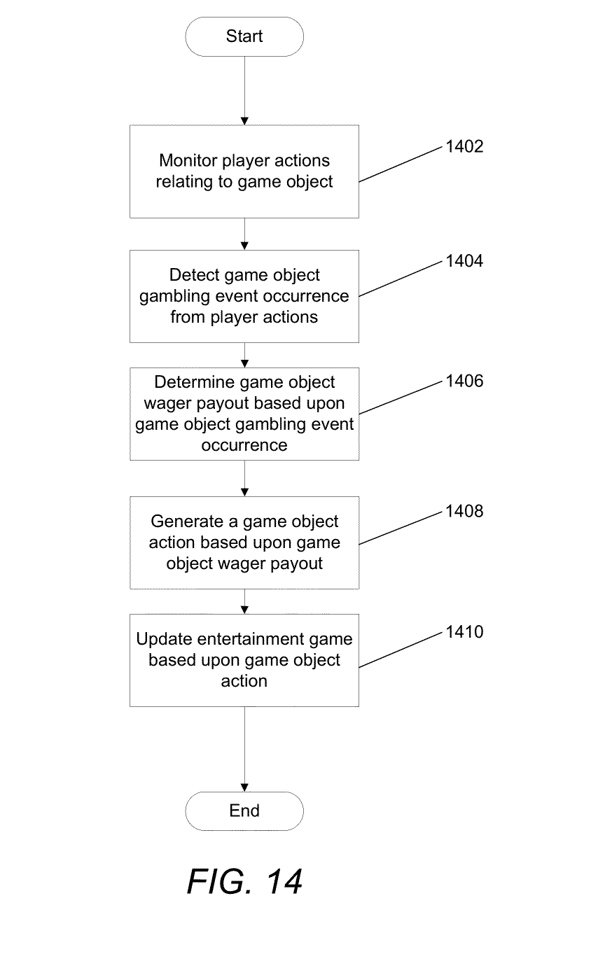

A flow chart of a process for updating an entertainment game based upon a game object action in accordance with an embodiment of the invention is illustrated in FIG. 14. The process includes monitoring (1402) player actions relating to a game object. Game object gambling event occurrences can be detected (1404) based upon at least one player action in accordance with at least one game object gambling event occurrence rule. A game object wager payout from a game object wager can be determined (1406) based upon the game object gambling event occurrence that triggers the game object wager. A game object action can be generated (1408) based upon the game object wager payout. An entertainment game can be updated (1410) based upon the game object action.

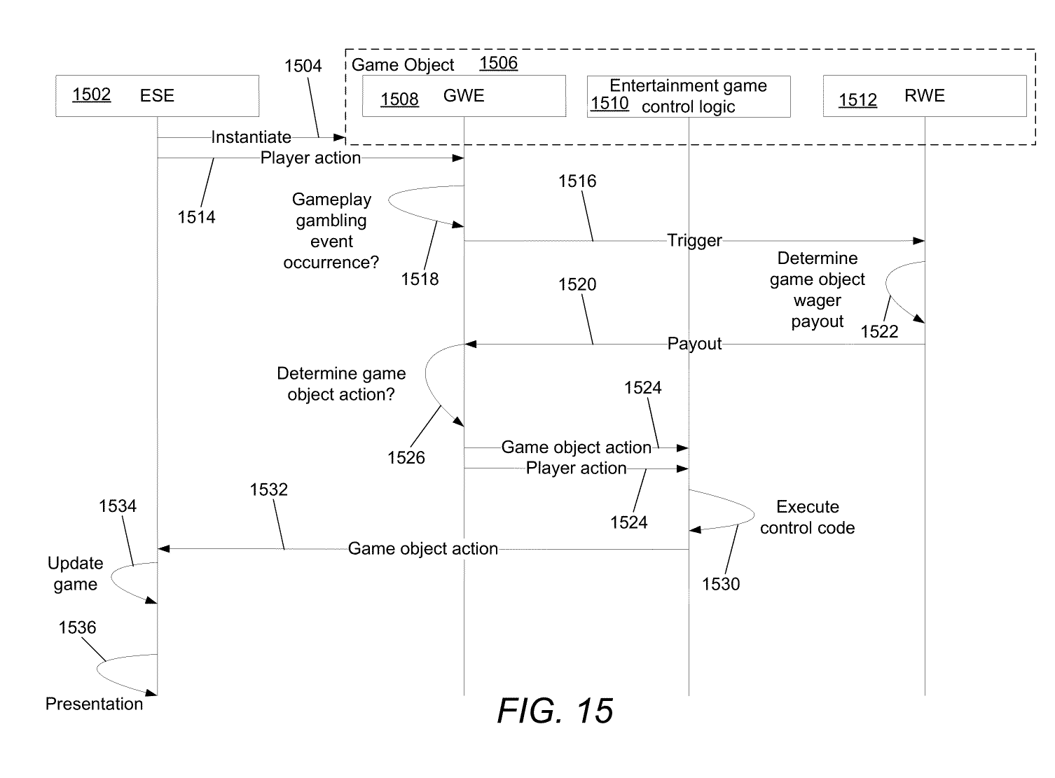

A timing diagram of a process for updating an entertainment game based upon a game object action using a real world engine in accordance with an embodiment of the invention is illustrated in FIG. 15. The process includes an ESE 1502 instantiating (1504) a game object by integrating the game object with the entertainment game as the entertainment game is configured. Information concerning a player action related to the game object can be sent (1514) from an ESE to a GWE 1508 of a game object 1506. The GWE 1508 of the game object 1506 can determine (1518) whether a gameplay gambling event occurrence has occurred based upon at least one player action related to the game object. Detection of a gameplay gambling event occurrence can be sent (1516) from a GWE 1508 to a RWE 1512 to trigger a game object wager to be executed by a RWE 1512 of a game object 1506. Game object wager terms can be dictated for the game object wager based upon any factor that can be used to determine a particular pay table to be used for a random value generated by a RNG of a RWE to generate a game object wager payout, such as but not limited to an amount of gameplay resources wagered, type of gameplay resources wagered or entertainment game gameplay progress. The RWE 1512 of a game object 1506 can determine (1522) a randomly generated game object wager payout with the wager terms in executing the game object wager. The game object wager payout can be communicated (1520) to the GWE 1508 of the game object 1506. In certain embodiments, the game object wager payout can be communicated to a GWE which can further determine how the gameplay resources associated with the game object wager payout is allocated. The GWE 1508 of the game object 1506 can utilize information concerning the game object wager payout to determine (1526) if a game object action is to be generated. The GWE 1508 of the game object 1506 can send (1524) a command to generate a game object action along with information that can be utilized in the generation of the game object action (such as but not limited to a player action used to determine the gameplay gambling event occurrence) to the entertainment game control logic of the game object. The entertainment game control logic 1510 can generate a game object action as information that is then communicated (1532) to an ESE 1502 to update (1534) the entertainment game and present (1536) the game object action within the context of an entertainment game.

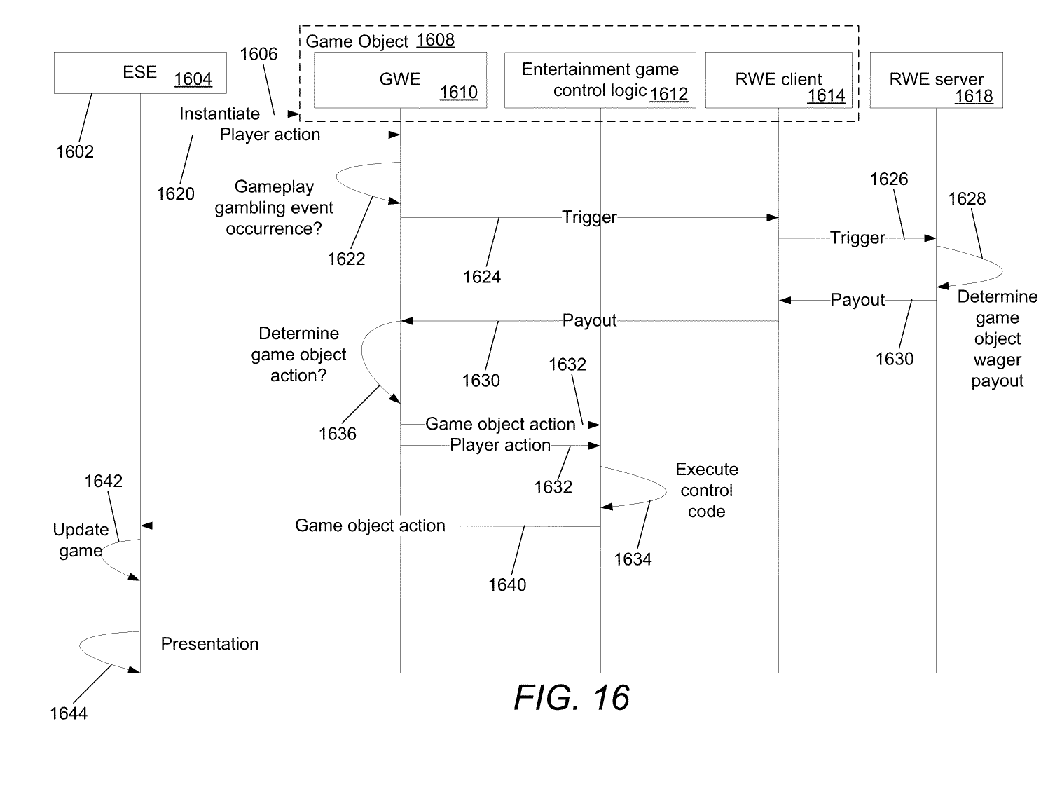

A timing diagram of a process for updating an entertainment game based upon a game object action using a real world engine distributed across a real world engine client and real world engine server in accordance with an embodiment of the invention is illustrated in FIG. 16. The process includes an ESE 1602 instantiating (1606) a game object by integrating the game object with the entertainment game as the entertainment game is configured. Information concerning a player action related to the game object can be sent (1620) from the ESE to a GWE of a game object. The GWE 1610 of the game object 1608 can determine (1622) whether a gameplay gambling event occurrence has occurred based upon at least one player action related to the game object. Detection of a gameplay gambling event occurrence can be communicated (1624) to an RWE client of a game object. The RWE client of the game object can communicate (1626) the gameplay gambling event occurrence to a RWE server 1618 that triggers a game object wager to be executed by the RWE server. In several embodiments, game object wager terms can also be communicated alongside the communication of the gameplay gambling event occurrence. Game object wager terms can be dictated for the game object wager based upon any factor that can be used to determine a particular pay table to be used for a random value generated by a RNG of a RWE to generate a game object wager payout, such as but not limited to the amount of gameplay resources wagered, type of gameplay resources wagered or entertainment game gameplay progress. The RWE server 1618 can determine (1628) a randomly generated game object wager payout in executing the game object wager. The game object wager payout can be communicated (1630) to the GWE of the game object through the RWE client. In certain embodiments, the game object wager payout can be communicated to a GWE which can further determine how the gameplay resources associated with the game object wager payout is allocated. The GWE 1610 of the game object 1608 can utilize information concerning the game object wager payout to determine (1636) if a game object action is to be generated. The GWE (1610) of the game object (1608) can send (1632) a command to generate a game object action along with information that can be utilized in the generation of the game object action (such as but not limited to a player action used to determine the gameplay gambling event occurrence) to the entertainment game control logic 1612 of the game object 1608. The entertainment game control logic can generate (1634) a game object action as information that is communicated (1640) to an ESE 1604 to update (1642) the entertainment game and present (1644) the game object action within the context of an entertainment game.

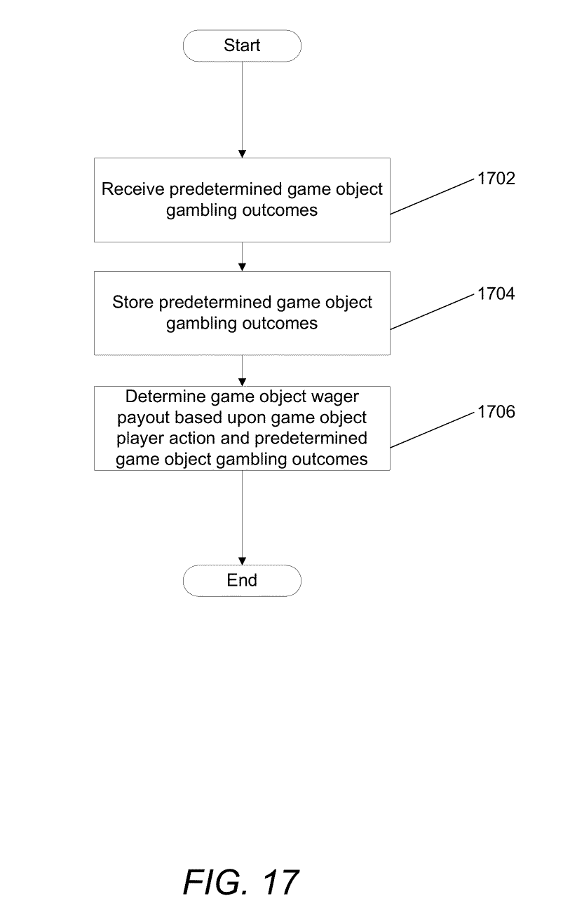

A flow chart of a process for determining a game object wager payout in accordance with an embodiment of the invention is illustrated in FIG. 17. The process includes retrieving (1702) predetermined gambling outcomes. The predetermined gambling outcomes can be stored (1704) for future use in determining a game object wager payout. A game object wager payout can be determined (1706) based upon the predetermined gambling outcome that includes a random value generated by an RNG of a GWE and a player action that triggered a game object wager. The predetermined gambling outcome can be utilized in choosing a pay table to be applied to the random value to generate a game object wager payout in accordance with a game object wager execution rule. In other embodiments, a game object wager payout can be generated by triggering a wager in real time (as opposed to using a predetermined gambling outcome).

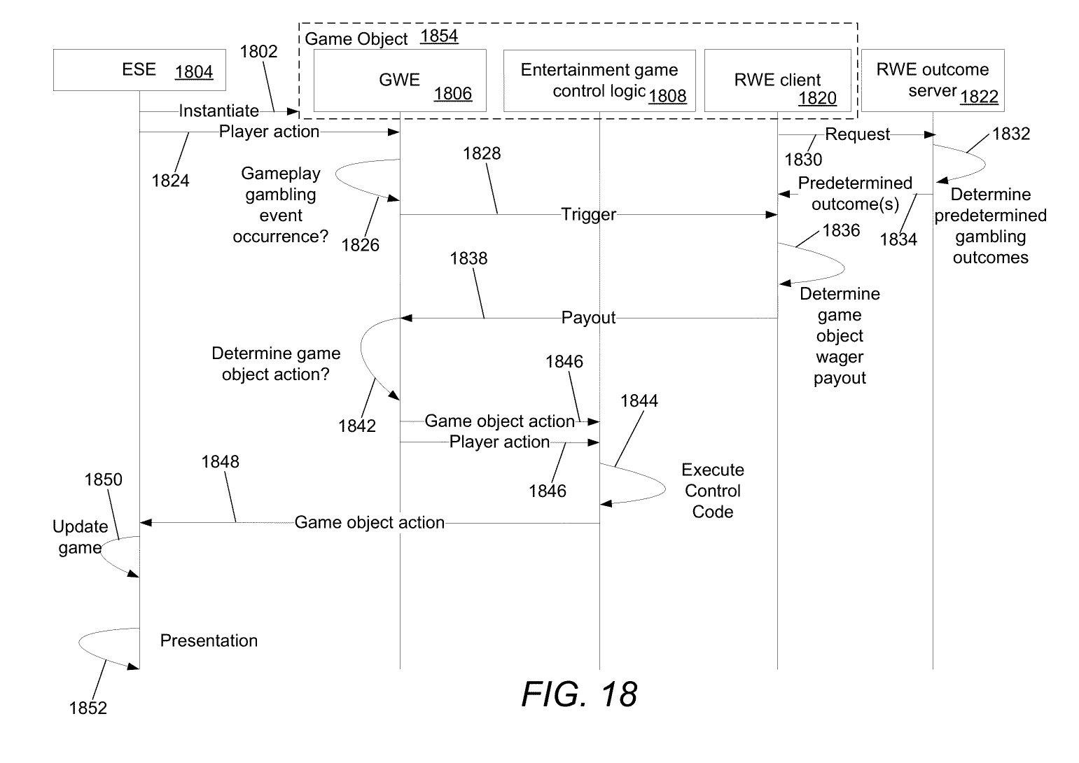

A timing diagram of a process for determining a game object wager payout using a RWE outcome server in accordance with an embodiment of the invention is illustrated in FIG. 18. The process includes an ESE 1804 instantiating a game object 1854 by integrating the game object with the entertainment game as the entertainment game is configured. A RWE client 1820 of the game object 1854 can send (1830) a request for at least one predetermined gambling outcome from a RWE outcome server 1822. The RWE outcome server 1822 can determine (1832) at least one predetermined gambling outcome and return (1834) at least one predetermined gambling outcome to the RWE client 1820. The RWE client 1820 can store the predetermined gambling outcomes for future use. Information concerning a player action related to the game object can be sent (1824) from the ESE to a GWE of a game object 1854. The GWE 1806 of the game object 1854 can determine (1826) whether a gameplay gambling event occurrence has occurred based upon at least one player action related to the game object. Detection of a gameplay gambling event occurrence can be communicated (1828) to the RWE client 1820 of a game object 1854. The gameplay gambling event occurrence can trigger a game object wager to be executed by the RWE client using the stored predetermined gambling outcomes. In several embodiments, game object wager terms can also be communicated alongside the communication of the gameplay gambling event occurrence. Game object wager terms can be dictated for the game object wager based upon any factor that can be used to determine a particular pay table to be used for a random value generated by a RNG of a RWE to generate a game object wager payout, such as but not limited to the amount of gameplay resources wagered, type of gameplay resources wagered or entertainment game gameplay progress. The RWE client 1820 can determine (1836) a game object wager payout in executing the game object wager using the predetermined outcomes received from the RWE outcome server 1822. The game object wager payout can be communicated 1838 to the GWE 1806 of the game object 1854. The GWE 1806 of the game object 1854 can utilize information concerning the game object wager payout to determine (1842) if a game object action is to be generated. The GWE 1806 of the game object can send (1846) a command to generate a game object action along with information that can be utilized in the generation of the game object action (such as but not limited to a player action used to determine the gameplay gambling event occurrence) to the entertainment game control logic of the game object. The entertainment game control logic 1808 can generate (1844) a game object action as information that is then communicated (1848) to an ESE 1804 to update (1850) the entertainment game and present (1852) the game object action within the context of an entertainment game.

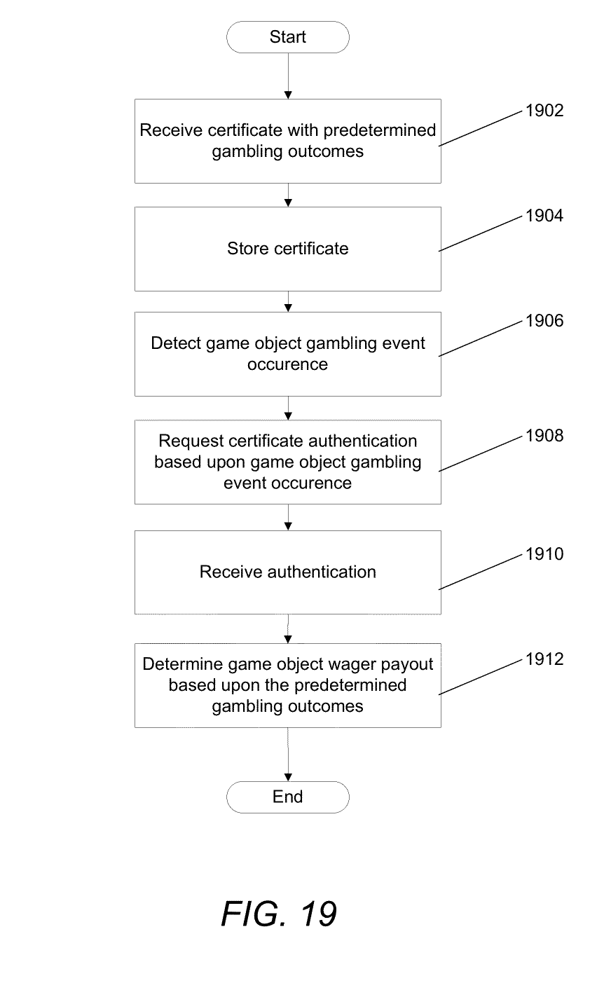

A flow chart of a process for determining a game object wager payout using a certificate with predetermined gambling outcomes in accordance with an embodiment of the invention is illustrated in FIG. 19. The process includes receiving (1902) a certificate with a predetermined gambling outcome, where the certificate is configured to be authenticated by a redemption server. The certificate can be stored (1904) for future use. A game object gambling event occurrence can be detected (1906) to trigger a game object wager. Certificate authentication can be requested (1908) from a redemption server during the execution of the game object wager. After receiving (1910) authentication of the certificate, a game object wager payout can be determined (1912) based upon the predetermined gambling outcomes associated with the authenticated certificate.

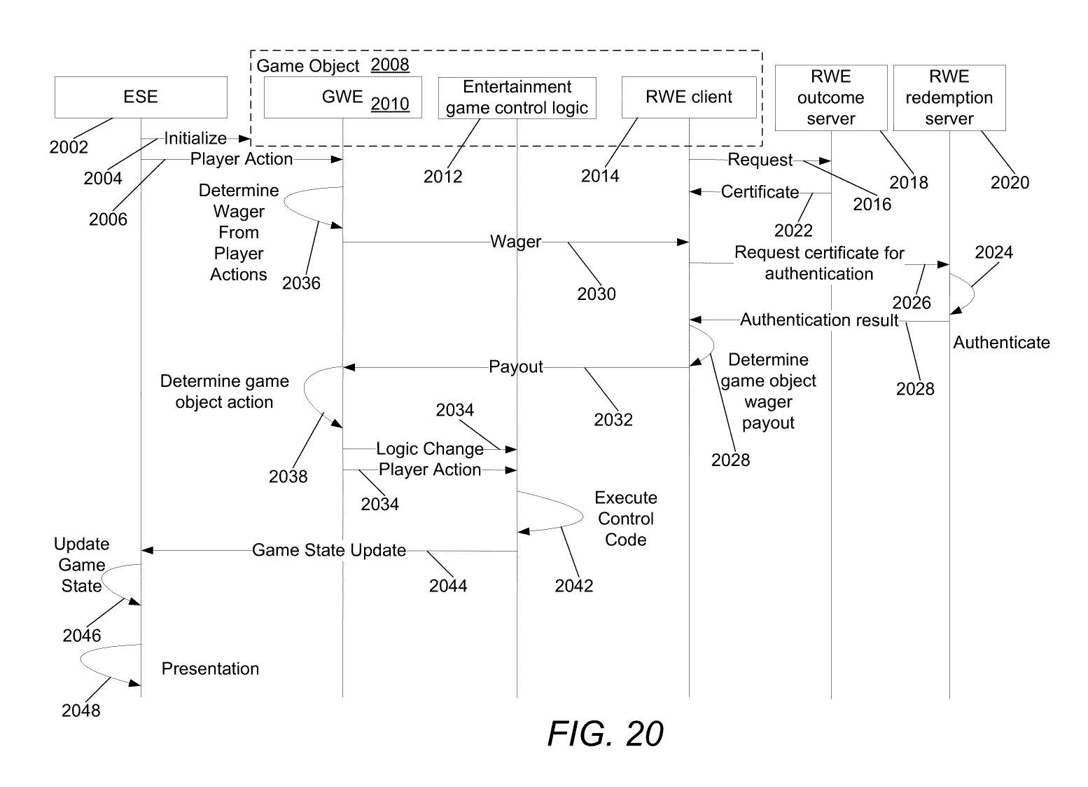

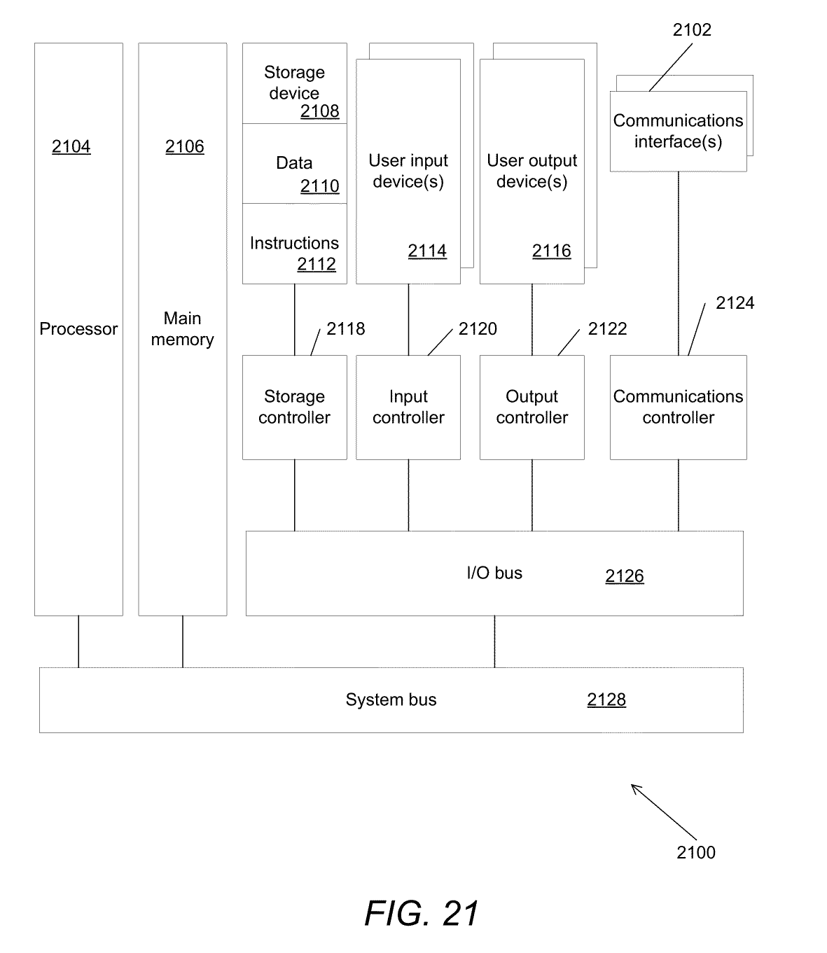

A timing diagram of a process for determining a game object wager payout using a certificate with predetermined gambling outcomes in accordance with an embodiment of the invention is illustrated in FIG. 20. The process includes an ESE 2002 instantiating (2004) a game object 2008 by integrating the game object with the entertainment game as the entertainment game is configured. A RWE client 2014 can request (2016) for at least one predetermined gambling outcomes from an RWE outcome server 2018. A RWE outcome server 2018 can send (2022) at least one certificate, configured to be authenticated by a RWE redemption server 2020 and which includes a predetermined gambling outcome, to the RWE client 2014. The RWE client 2014 can store the at least one certificate for future use. Information concerning a player action related to the game object can be sent (2006) from an ESE 2002 to a GWE 2010 of a game object 2008. The GWE 2010 of the game object 2008 can determine (2036) whether a gameplay gambling event occurrence has occurred based upon at least one player action related to the game object. Detection of a gameplay gambling event occurrence can be communicated (2030) to an RWE client 2014 of a game object 2008. The gameplay gambling event occurrence can trigger a game object wager to be executed by requesting (2026) authentication of a certificate associated with the gameplay gambling event occurrence to a RWE redemption server 2020. The RWE redemption server 2020 can authenticate (2024) the certificate and send (2028) the authentication results back to the RWE client 2014. The RWE client 2014 can utilize the authenticated certificate along with associated predetermined gambling outcomes to determine (2028) a game object wager payout. In several embodiments, game object wager terms can also be communicated alongside the communication of the gameplay gambling event occurrence. Game object wager terms can be dictated for the game object wager based upon any factor that can be used to determine a particular pay table to be used for a random value generated by a RNG of a RWE to generate a game object wager payout, such as but not limited to the amount of gameplay resources wagered, type of gameplay resources wagered or entertainment game gameplay progress. The game object wager payout can be communicated (2032) to the GWE 2010 of the game object 2008. The GWE 2010 of the game object 2008 can utilize information concerning the game object wager payout to determine (2038) if a game object action is to be generated. The GWE 2010 of the game object 2008 can send (2034) a command to generate a game object action along with information that can be utilized in the generation of the game object action (such as but not limited to a player action used to determine the gameplay gambling event occurrence) to the entertainment game control logic 2012 of the game object 2008. The entertainment game control logic 2008 can generate (2042) a game object action as information that is communicated (2044) to an ESE 2002 to update the entertainment game (2046) and present the game object action (2048) within the context of an entertainment game. In certain embodiments, a RWE outcome server and an RWE redemption server are hosted on a same device.

Although various constructions of game object modules are discussed above, game object modules can be constructed to facilitate game object gambling hybrid game gameplay as appropriate to the specifications of a specific application in accordance with embodiments of the invention. In certain embodiments, services performed by various servers, such as a RWE server, RWE outcome server and RWE redemption server, can be performed by a same server. Processing apparatuses that can be implemented in a game object gambling hybrid game are discussed below.

### Processing Apparatuses

Any of a variety of processing apparatuses can host various components of a game object gambling hybrid game in accordance with embodiments of the invention. In several embodiments, these processing apparatuses can include, but are not limited to, a gaming machine, a general purpose computer, a computing device and/or a controller. A processing apparatus that is constructed to implement a game object gambling hybrid game in accordance with an embodiment of the invention is illustrated in FIG. 15. In the processing apparatus 1500, a processor 1504 is coupled to a memory 1506 by a bus 1528. The processor 1504 is also coupled to non-transitory processor-readable storage media, such as a storage device 1508 that stores processor-executable instructions 1512 and data 1510 through the system bus 1528 to an I/O bus 1526 through a storage controller 1518. The processor 1504 is also coupled to one or more interfaces that can be used to connect the processor to other processing apparatuses as well as networks as described herein. The processor 1504 is also coupled via the bus to user input devices 1514, such as tactile devices including but not limited to keyboards, keypads, foot pads, touch screens, and/or trackballs, as well as non-contact devices such as audio input devices, motion sensors and motion capture devices that the processing apparatus can use to receive inputs from a user when the user interacts with the processing apparatus. The processor 1504 is connected to these user input devices 1514 through the system bus 1528, to the I/O bus 1526 and through the input controller 1520. The processor 1504 is also coupled via the bus to user output devices 1516 such as (but not limited to) visual output devices, audio output devices, and/or tactile output devices that the processing apparatus uses to generate outputs perceivable by the user when the user interacts with the processing apparatus. In several embodiments, the processor is coupled to visual output devices such as (but not limited to) display screens, light panels, and/or lighted displays. In a number of embodiments, the processor is coupled to audio output devices such as (but not limited to) speakers, and/or sound amplifiers. In many embodiments, the processor is coupled to tactile output devices like vibrators, and/or manipulators. The processor is connected to output devices from the system bus 1528 to the I/O bus 1526 and through the output controller 1522. The processor 1504 can also be connected to a communications interface 1502 from the system bus 1528 to the I/O bus 1526 through a communications controller 1524.

In various embodiments, a processor can load instructions and data from the storage device into the memory. The processor can also execute instructions that operate on the data to implement various aspects and features of the components of a game object gambling hybrid game. The processor can utilize various input and output devices in accordance with the instructions and the data in order to create and operate user interfaces for players or operators of a game object gambling hybrid game (such as but not limited to a casino that hosts the game object gambling hybrid game).

Although the processing apparatus is described herein as being constructed from a processor and instructions stored and executed by hardware components, the processing apparatus can be composed of only hardware components in accordance with many embodiments. In addition, although the storage device is described as being coupled to the processor through a bus, those skilled in the art of processing apparatuses will understand that the storage device can include removable media such as but not limited to a USB memory device, an optical CD ROM, magnetic media such as tape and disks. Also, the storage device can be accessed through one of the interfaces or over a network. Furthermore, any of the user input devices or user output devices can be coupled to the processor via one of the interfaces or over a network. In addition, although a single processor is described, those skilled in the art will understand that the processor can be a controller or other computing device or a separate computer as well as be composed of multiple processors or computing devices.

In numerous embodiments, any of an RWE, GWE or ESE as described herein can be implemented on multiple processing apparatuses, whether dedicated, shared or distributed in any combination thereof, or can be implemented on a single processing apparatus. In addition, while certain aspects and features of element management processes described herein have been attributed to an RWE, GWE, or ESE, these aspects and features can be implemented in a hybrid form where any of the features or aspects can be performed by any of a RWE, GWE, ESE within a game object gambling hybrid game without deviating from the spirit of the invention.

While the above description contains many specific embodiments of the invention, these should not be construed as limitations on the scope of the invention, but rather as an example of one embodiment thereof. It is therefore to be understood that the present invention can be practiced otherwise than specifically described, without departing from the scope and spirit of the present invention. Thus, embodiments of the present invention should be considered in all respects as illustrative and not restrictive.

What is claimed is:

1. A game object gambling hybrid game, comprising:
a real world engine constructed to:
receive from a game object, a trigger of a wager of real world credits;
determine a gambling outcome of the wager of real world credits; and
transmit the gambling outcome to the game object; and
an entertainment software engine coupled to the real world engine, the entertainment software engine constructed to:
execute an entertainment game providing entertainment game outcomes based upon skillful execution of the entertainment game; and
modify entertainment game gameplay of the entertainment game based upon a game object action related to the game object, wherein the game object is constructed to:
communicate the trigger to the real world engine, the trigger determined by detection of a player action in the entertainment game that satisfies a gambling event occurrence rule, whereby the player action triggers the wager of real world credits in the real world engine;
receive the gambling outcome from the real world engine;
generate the game object action based upon the gambling outcome in accordance with a game object wager payout rule; and
communicate the game object action to the entertainment software engine.

2. The game object gambling hybrid game of claim 1, wherein the real world engine and the game object communicate via a network.

3. The game object gambling hybrid game of claim 1, wherein the gambling outcome is a predetermined gambling outcome.

4. The game object gambling hybrid game of claim 1, wherein the game object gambling event occurrence rule detects the player action a consumption of one or more elements in the entertainment game, wherein the one or more elements are a limited resource consumed within the entertainment game to advance entertainment game gameplay.

5. The game object gambling hybrid game of claim 4, wherein the game object action includes restoration of the one or more elements to the entertainment game.

6. The game object gambling hybrid game of claim 1, wherein the game object gambling event occurrence rule detects the player action as an achievement of a combination of elements associated with a player profile, where the elements are a limited resource consumed within the entertainment game to advance entertainment game gameplay.

7. The game object gambling hybrid game of claim 1, wherein the game object is further constructed to utilize a wager term configuration rule that configures wager terms based upon the game object gambling event occurrence.

8. The game object gambling hybrid game of claim 1, wherein the game object is a game object server coupled to the entertainment software engine.

9. The game object gambling hybrid game of claim 1, wherein the entertainment software engine is further constructed to:
request the game object from a game object server; and
install the game object in the entertainment game.

10. A method of a game object gambling hybrid game, comprising:
executing by first one or more processors a real world engine process comprising:
receiving from a game object, a trigger of a wager of real world credits;
determining a gambling outcome of the wager of real world credits; and
transmitting the gambling outcome to the game object;
executing by second one or more processors an entertainment software engine process comprising:
executing an entertainment game providing entertainment game outcomes based upon skillful execution of the entertainment game; and
modifying entertainment game gameplay of the entertainment game based upon a game object action related to the game object; and
executing by the second one or more processors a game object process comprising:
communicating the trigger to the real world engine process, the trigger determined by detection of a player action in the entertainment game that satisfies a gambling event occurrence rule, whereby the player action triggers the wager of real world credits in the real world engine process;
receiving the gambling outcome from the real world engine;
generating the game object action based upon the gambling outcome in accordance with a game object wager payout rule; and
communicating the game object action to the entertainment software engine process.

11. The method of claim 10, wherein the real world engine process and the game object process communicate via a network.

12. The method of claim 10, wherein the gambling outcome is a predetermined gambling outcome.

13. The method of claim 10, wherein the game object gambling event occurrence rule detects the player action a consumption of one or more elements in the entertainment game, wherein the one or more elements are a limited resource consumed within the entertainment game to advance entertainment game gameplay.

14. The method of claim 13, wherein the game object action includes restoration of the one or more elements to the entertainment game.

15. The method of claim 10, wherein the game object gambling event occurrence rule detects the player action as an achievement of a combination of elements associated with a player profile, where the elements are a limited resource consumed within the entertainment game to advance entertainment game gameplay.

16. The method of claim 10, wherein the game object process further comprises utilizing a wager term configuration rule that configures wager terms based upon the game object gambling event occurrence.

17. The method of claim 10, wherein the entertainment software engine process further comprises:
requesting a game object of the game object process from a game object server; and
installing the game object in the entertainment game.
